(19) United States
(12) Patent Application Publication
(10) Pub. No.: US 2023/0222100 A1
(43) Pub. Date: Jul. 13, 2023

(54) METHODS AND SYSTEMS FOR REDUCING THE STORAGE VOLUME OF LOG MESSAGES

(71) Applicant: VMware, Inc., Palo Alto, CA (US)

(72) Inventors: Ashot Harutyunyan, Yerevan (AM); Arnak Poghosyan, Yerevan (AM); Naira Movses Grigoryan, Yerevan (AM)

(73) Assignee: VMware, Inc., Palo Alto, CA (US)

(21) Appl. No.: 17/573,539

(22) Filed: Jan. 11, 2022

(51) Int. Cl. G06F 16/17; G06F 16/174; G06F 16/182; G06F 16/16

(52) U.S. Cl. CPC G06F 16/1734; G06F 16/162; G06F 16/1727; G06F 16/1748; G06F 16/1824

(57) ABSTRACT

Automated methods and systems for compressing log messages stored in a log message databased are described herein. The automated methods and systems perform lossy compression of an original set of log messages by identifying log messages that represent each of the various types of events recorded in the original set. The log messages in the original set are overwritten by corresponding representative log messages. Source coding is used to construct a source coding scheme and variable length binary codewords for each of the representative log messages. The representative log messages are replaced by the codewords, which occupies significantly less storage space than the original set. The lossy compressed set of log messages can be decompressed to obtain the representative log messages using the source coding scheme.

### TECHNICAL FIELD

This disclosure is directed to storing log messages generated in a distributed computing system.

### BACKGROUND

Electronic computing has evolved from primitive, vacuum-tube-based computer systems, initially developed during the 1940s, to modern electronic computing systems in which large numbers of multi-processor computer systems are networked together with large-capacity data-storage devices and other electronic devices to produce geographically distributed data centers that provide enormous computational bandwidths and data-storage capacities. Data centers are made possible by advances in virtualization, computer networking, distributed operating systems and applications, data-storage appliances, computer hardware, and software technologies. In recent years, an increasing number of businesses, governments, and other organizations rent data processing services and data storage space as data center tenants. Data center tenants conduct business and provide cloud services over the internet on software platforms that are maintained and run entirely in data centers, which reduces the cost of maintaining their own centralized computing networks and hosts.

Because data centers have an enormous number of computational resources and execute thousands of applications, various management systems have been developed to collect performance information and aid systems administrators and data center tenants with detection of system problems. A typical log management server, for example, records log messages generated by various operating systems and applications running in a data center in log files. Each log message is an unstructured or semi-structured time-stamped message that records information about the state of an operating system, state of an application, state of a service, or state of computer hardware at a point in time. Most log messages record normal events, such as input/output operations, client requests, logins, logouts, and statistical information about the execution of applications, operating systems, computer systems, and other devices of a data center. For example, a web server executing on a computer system generates a stream of log messages, each of which describes a date and time of a client request, web address requested by the client, and IP address of the client. Other less frequently generated log messages record abnormal events, such as alarms, warnings, errors, or emergencies occurring with applications, operating systems, and hardware. Data center tenants maintain log files because the log files contain information that can be used to discover patterns of application incidents, train models that predict application behavior, and identify root causes of problems with an application.

However, vast numbers of log files are generated each day with most log files exceeding a tera byte of data. These large volume log files are expensive for data center tenants to maintain in data storage. Large volume log files also slow the process of detecting problems recorded in log messages. For example, a search for log messages that describe a problem with a tenant’s application is typically performed by teams of engineers, such as a field engineering team, an escalation engineering team, and a research and development engineering team. Each team searches for a root cause of a problem by gradually filtering log messages through different sub-teams. However, because of the enormously large size of most log files, the troubleshooting process can take days and weeks, and in some cases months. Data center tenants cannot afford long periods of time spent searching log files for a root cause of a problem. Problems with a data center tenant’s applications result in downtime or slow performance of their applications. Such problems frustrate users, damage a brand name, cause lost revenue, and deny people access to vital services. Systems administrators and data center tenants seek automated methods and systems that reduce the size of log files and thereby reduce tenant costs and shorten the time to detection of root causes of problems.

### SUMMARY

This disclosure is directed to automated methods and systems for compressing log messages stored in a log message databased. The automated methods and systems perform lossy compression of an original set of log messages by identifying log messages that best represent each of the various types of events recorded in the original set. The log messages in the original set are overwritten by the representative log messages that correspond to the event types of the log messages. Source coding is used to construct a source coding tree, or a source coding table, and variable length binary codewords for each of the representative log messages. The representative log messages are replaced by the codewords to obtain a lossy compressed set of log messages, which occupies significantly less storage space than the original set of log messages. The lossy compressed set of log messages can be decompressed to obtain the representative log messages using the source coding tree or the source coding table.

### DESCRIPTION OF THE DRAWINGS

FIG. 1 shows an example of logging log messages in log files.

FIG. 2 shows an example source code of an event source.

FIG. 3 shows an example of a log write instruction.

FIG. 4 shows an example of a log message generated by the log write instruction in FIG. 3.

FIG. 5 shows a small, eight-entry portion of a log file.

FIGS. 6A-6C show an example of the log management server receiving log messages from event sources.

FIG. 7 shown a table of examples of regular expressions designed to match particular character strings of log messages.

FIG. 8 shows a table of example date and time formats often used to record the date and time in log messages and matching regular expressions.

FIG. 9 shows a table of examples of primary Grok patterns.

FIG. 10 shows a table of examples of composite Grok patterns.

FIG. 11 shows an example of a log message and an associated Grok expression configured to match character strings of the log message.

FIG. 12 shows an implementation architecture for a log management server that generates a Grok expression graph and generates a Grok expression from a sample log message.

FIG. 13 shows an example original set of log messages of a log file partitioned into separate groups log messages based on event type.

FIG. 14 shows examples of representative log messages identified for each of the log message groups in FIG. 13.

FIG. 15 shows an example of a lossy set of log messages obtained by replacing log messages of the original set of log messages with corresponding replacement log messages.

FIG. 16 shows a plot of an example probability distribution and a plot of a reordered probability distribution.

FIGS. 17A-17K show an example of constructing a source coding tree based on an example ordered probability distribution.

FIG. 18A shows an example table that represents an iterative process of constructing variable length codewords.

FIG. 18B shows a source coding table for encoding replacement log messages with codewords.

FIG. 19 shows an example of compressing representative log messages of a lossy set of log messages into corresponding codewords.

FIG. 20 shows an example of a lossy compressed set of log messages.

FIG. 21 shows an ASCII code representation of a representative log message and a corresponding codeword.

FIG. 22 shows an example decompressing a lossy compressed set of log messages to obtain a lossy set of log messages.

FIG. 23 is a flow diagram illustrating an example implementation of a “method for compressing log messages.”

FIG. 24 is a flow diagram of the “overwrite the log messages with representative log messages of the log messages” process performed in FIG. 23.

FIG. 25 is a flow diagram of the “form the log messages into the log message groups based on event types of the log message” process performed in FIG. 24.

FIG. 26 is a flow diagram of the “determine a representative log message for each log message group” process performed in FIG. 24.

FIG. 27 is a flow diagram of the “compress the representative log message to obtain a lossy compressed set of log messages” process performed in FIG. 23.

FIG. 28 shows an example of a computer system that may be used to host a log management server.

### DETAILED DESCRIPTION

This disclosure is directed to automated methods and systems for compressing log files. Log messages and log files are described below in a first section. An example of a log management server is described below in a second section. Extraction of event types from log messages are described in a third sections. Automated methods and systems for compressing log message are described below in a fourth subsection.

### Log Messages and Log Files

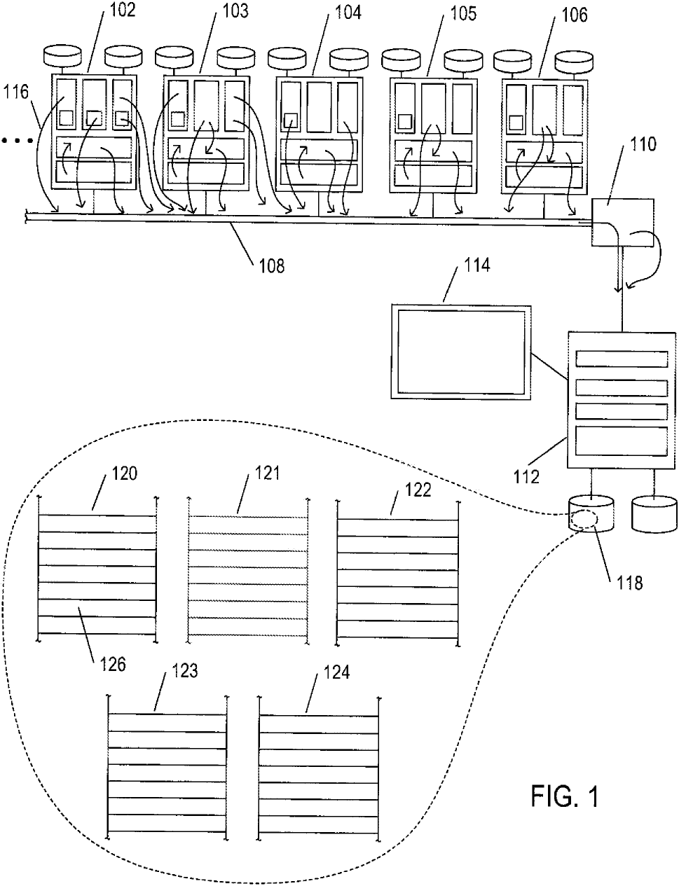

FIG. 1 shows an example of logging log messages in log files. In FIG. 1, computer systems 102-106 within a distributed computing system, such as data center, are linked together by an electronic communications medium 108 and additionally linked through a communications bridge/router 110 to an administration computer system 112 that includes an administrative console 114 and executes a log management server described below. Each of the computer systems 102-106 may run a log monitoring agent that forwards log messages to the log management server executing on the administration computer system 112. As indicated by curved arrows, such as curved arrow 116, multiple components within each of the discrete computer systems 102-106 as well as the communications bridge/router 110 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 102-106, the bridge/router 110 and any other components of a data center. Log messages may be received by log monitoring agents at various hierarchical levels within a discrete computer system and then forwarded to the log management server executing in the administration computer system 112. The log management server records the log messages in a data-storage device or appliance 118 as log files 120-124. Rectangles, such as rectangle 126, represent individual log messages. For example, log file 120 may contain a list of log messages generated within the computer system 102. Each log monitoring agent has a configuration that includes a log path and a log parser. The log path specifies a unique file system path in terms of a directory tree hierarchy that identifies the storage location of a log file on the administration computer system 112 or the data-storage device 118. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 112 and computer systems 102-106 may function without log monitoring agents and a log management server, but with less precision and certainty.

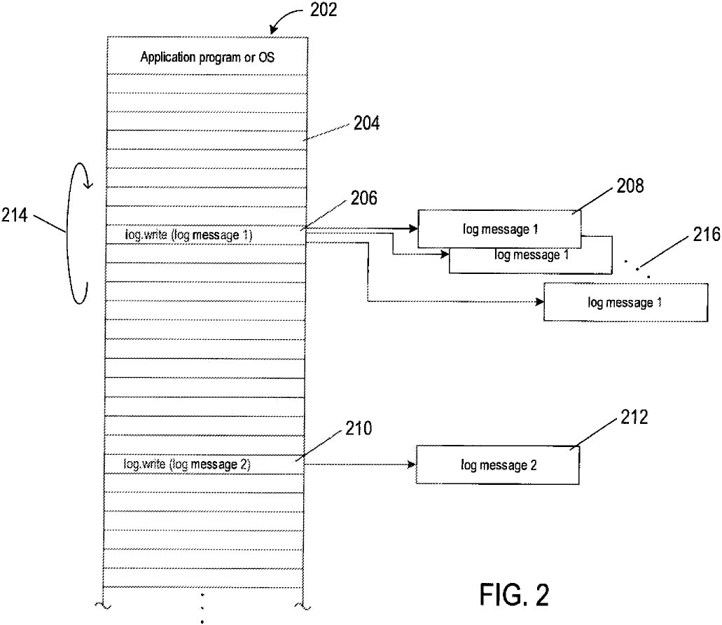

FIG. 2 shows an example source code 202 of an event source. The event source can be an application, an operating system, a VM, a guest operating system, or any other computer program or machine code that generates log messages. The source code 202 is just one example of an event source that generates log messages. Rectangles, such as rectangle 204, represent a definition, a comment, a statement, or a computer instruction that expresses some action to be executed by a computer. The source code 202 includes log write instructions that generate log messages when certain events predetermined by a developer occur during execution of the source code 202. For example, source code 202 includes an example log write instruction 206 that when executed generates a “log message 1” represented by rectangle 208, and a second example log write instruction 210 that when executed generates “log message 2” represented by rectangle 212. In the example of FIG. 2, the log write instruction 208 is embedded within a set of computer instructions that are repeatedly executed in a loop 214. As shown in FIG. 2, the same log message 1 is repeatedly generated 216. The same type of log write instructions may also be located in different places throughout the source code, which in turns creates repeats of essentially the same type of log message in the log file.

In FIG. 2, the notation “log.write()” is a general representation of a log write instruction. In practice, the form of the log write instruction varies for different programming languages. In general, the log write instructions are determined by the developer and are unstructured, or semi-structured, and in many cases are relatively cryptic. For example, log write instructions may include instructions for time stamping the log message and contain a message comprising natural-language words and/or phrases as well as various types of text strings that represent file names, path names, and perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination: and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

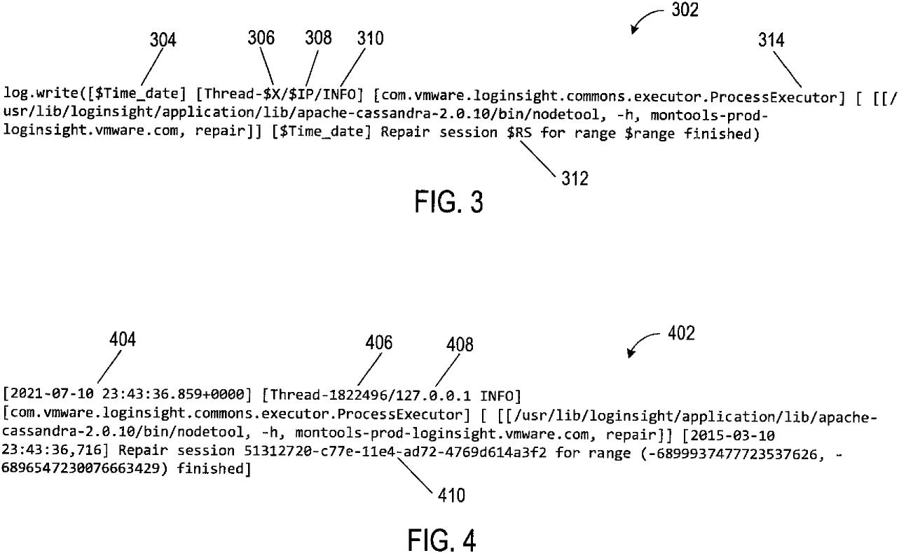

FIG. 3 shows an example of a log write instruction 302. The log write instruction 302 includes arguments identified with “$” that are filled at the time the log message is created. For example, the log write instruction 302 includes a time-stamp argument 304, a thread number argument 306, and an internet protocol (“IP”) address argument 308. The example log write instruction 302 also includes text strings and natural-language words and phrases that identify the level of importance of the log message 310 and type of event that triggered the log write instruction, such as “Repair session” argument 312. The text strings between brackets “[ ]” represent file-system paths, such as path 314. When the log write instruction 302 is executed by a log management agent, parameters are assigned to the arguments and the text strings and natural-language words and phrases are stored as a log message of a log file.

FIG. 4 shows an example of a log message 402 generated by the log write instruction 302. The arguments of the log write instruction 302 may be assigned numerical parameters that are recorded in the log message 402 at the time the log message is executed by the log management agent. For example, the time stamp 304, thread 306, and IP address 308 arguments of the log write instruction 302 are assigned corresponding numerical parameters 404,406, and 408 in the log message 402. Alphanumeric expression 410 is assigned to a repair session argument 312. The time stamp 404 represents the date and time the log message 402 is generated. The text strings and natural-language words and phrases of the log write instruction 302 also appear unchanged in the log message 402 and may be used to identify the type of event (e.g., informative, warning, error, or fatal) that occurred during execution of the event source.

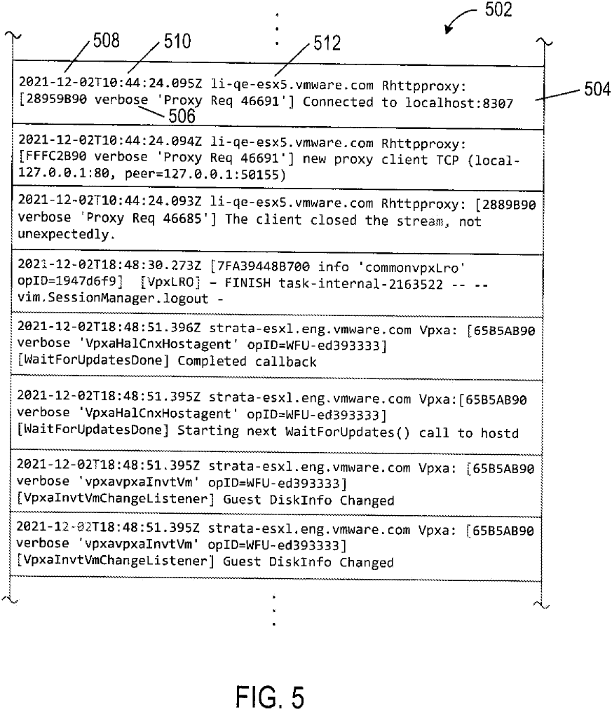

As log messages are received from various event sources, the log messages are stored in corresponding log files in the order in which the log messages are received. FIG. 5 shows a small, eight-entry portion of a log file 502. In FIG. 5, each rectangular cell, such as rectangular cell 504, of the log file 502 represents a single stored log message. For example, log message 504 includes a short natural-language phrase 506, date 508 and time 510 numerical parameters, and an alphanumeric parameter 512 that identifies a particular host computer.

### Log Management Server

In large, distributed computing systems, such as data centers, terabytes of log messages are generated each day. The log messages are sent to a log management server that records the log messages in log files that are in turn stored and maintained as log message databases in data-storage appliances.

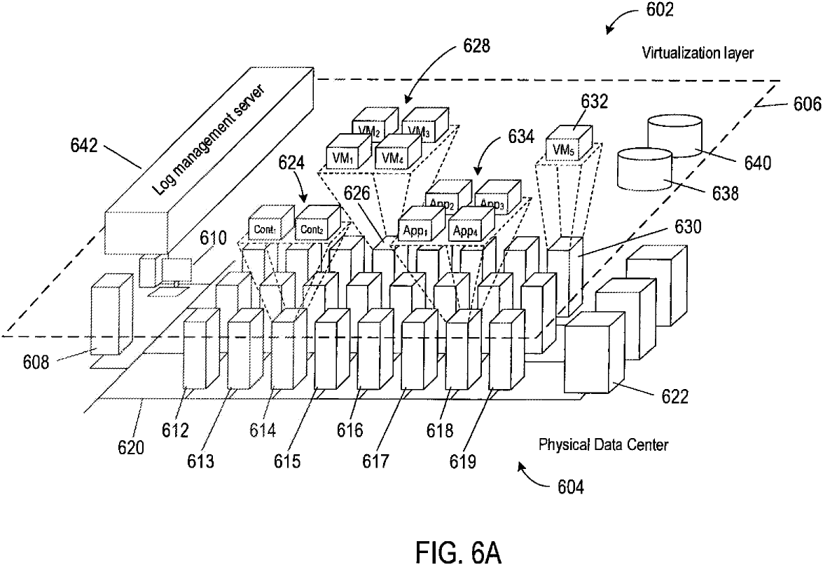

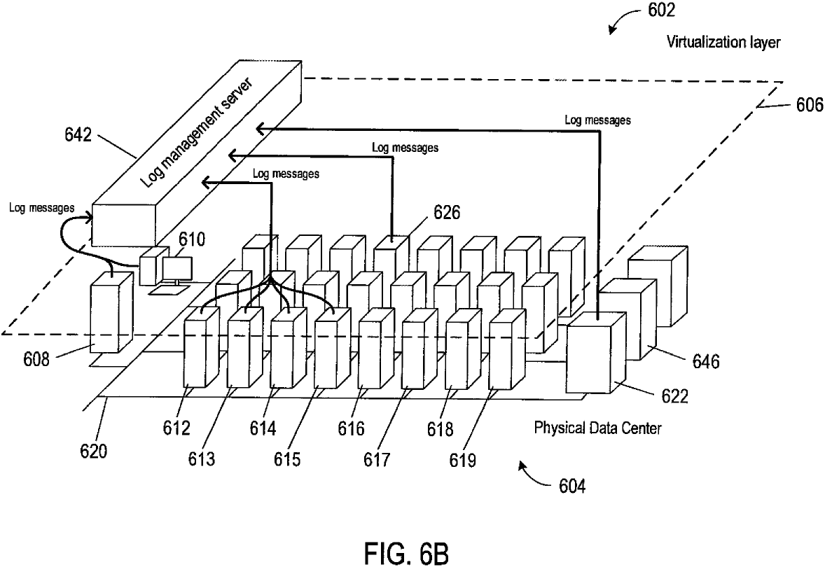

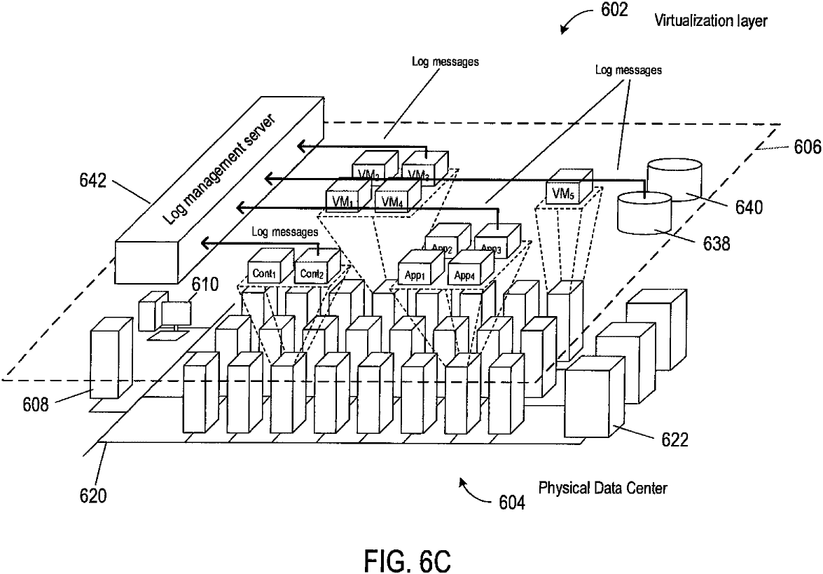

FIG. 6A shows an example of a virtualization layer 602 located above a physical data center 604. For the sake of illustration, the virtualization layer 602 is separated from the physical data center 604 by a virtual-interface plane 606. The physical data center 604 is an example of a distributed computing system. The physical data center 604 comprises physical objects, including an administration computer system 608, any of various computers, such as PC 610, on which a virtual-data-center (“VDC”) management interface may be displayed to system administrators and other users, server computers, such as server computers 612-619, data-storage devices, and network devices. The server computers may be networked together to form networks within the data center 604. The example physical data center 604 includes three networks that each directly interconnects a bank of eight server computers and a mass-storage array. For example, network 620 interconnects server computers 612-619 and a mass-storage array 622. Different physical data centers may include many different types of computers, networks, data-storage systems, and devices connected according to many different types of connection topologies. The virtualization layer 602 includes virtual objects, such as VMs, applications, and containers, hosted by the server computers in the physical data center 604. The virtualization layer 602 may also include a virtual network (not illustrated) of virtual switches, routers, load balancers, and network interface cards formed from the physical switches, routers, and network interface cards of the physical data center 604. Certain server computers host VMs and containers as described above. For example, server computer 614 hosts two containers 624, server computer 626 hosts four VMs 628, and server computer 630 hosts a VM 632. Other server computers may host applications as described above with reference to FIG. 4. For example, server computer 618 hosts four applications 634. The virtual-interface plane 606 abstracts the resources of the physical data center 604 to one or more VDCs comprising the virtual objects and one or more virtual data stores, such as virtual data stores 638 and 640. For example, one VDC may comprise VMs 628 and virtual data store 638. Automated methods and systems described herein are executed by a log management server 642 implemented in one or more VMs on the administration computer system 608. The log management server 642 receives log messages generated by event sources and records the log messages in log files as described below.

FIGS. 6B-6C show the example log management server 642 receiving log messages from event sources. Directional arrows represent log messages sent to the log management server 642. In FIG. 6B, operating systems and applications running on PC 610, server computers 608 and 644, network devices, and mass-storage array 646 send log messages to the log management server 642. Operating systems and applications running on clusters of server computers may also send log messages to the log management server 642. For example, a cluster of server computers 612-615 sends log messages to the log management server 642. In FIG. 6C, guest operating systems, VMs, containers, applications, and virtual storage may independently send log messages to the log management server 642.

### Extraction of Event Types from Log Messages

The log management server 642 executes automated methods of compressing log messages of a log file in a user selected time window denoted by [tᵢₙ, t_{fin}], where tᵢₙ denotes an initial time, and t_{fin} denotes a final time. The log management server 642 begins the method of compression by extracting tokens from each log message of the log file in the time window [tᵢₙ, t_{fin}] in order to determine the type of event recorded in each of the log messages. A token is a separate string of symbols and/or characters. A token can be a parametric token that corresponds to a variable string, such as a numerical value, time, date, or IP address, or a non-parametric token that correspond to a static or non-changing string of a log message, such as a word, a path, or a file name. The non-parametric tokens reveal the type of event, called the “event type,” recorded in the log message.

In one implementation, the log management server 642 extracts tokens from log messages using regular expressions. A regular expression, also called “regex,” is a sequence of symbols that defines a search pattern in text data. Each regex symbol matches a single character in a log message. The follow description of regular expressions and examples of regular expressions is not intended to be an exhaustive description of regular expressions and their use to match characters and character strings in log messages.

Many regex symbols match letters and numbers. For example, the regex symbol “a” matches the letter “a,” but not the letter “b,” and the regex symbol “1θθ” matches the number “100,” but not the number 101. The regex symbol “.” matches any character. For example, the regex symbol “.art” matches the words “dart,” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d ” that matches a digit in 0123456789, a “ \s ” matches a white space, and a “ \b ” matches a word boundary. A string of characters enclosed by square brackets, [ ], matches any one character in that string. A minus sign “-” within square brackets indicates a range of consecutive ASCII characters. For example, the regex [aeiou] matches any vowel, the regex [a-f] matches a letter in the letters abcdef, the regex [0-9] matches a 0123456789, the regex [._%+-] matches any one of the characters ._%+-. The regex [0-9a-f] matches a number in 0123456789 and a single letter in abcdef. For example, [θ-9a-f] matches a6, i5, and u2 but does not match ex, 9v, or %6. Regular expressions separated a vertical bar “|” represent an alternative to match the regex on either side of the bar. For example, the regular expression Get | GetValue | Set | Setvalue matches any one of the words: Get, GetValue, Set, or SetValue. The braces “{}” following square brackets may be used to match more than one character enclosed by the square brackets. For example, the regex [θ-9]{2} matches two-digit numbers, such as 14 and 73 but not 043 and 4, and the regex [0-9] {1-2} matches any number between 0 and 99, such as 3 and 58 but not 349.

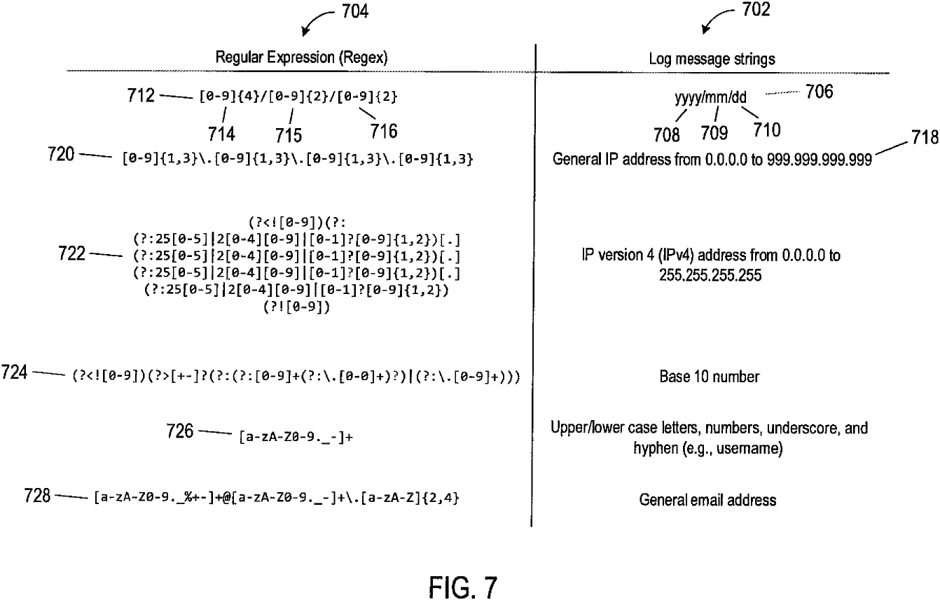

Simple regular expressions are combined to form larger regular expressions that match character strings of log messages and can be used to extract the character strings from the log messages. FIG. 7 shown a table of examples of regular expressions designed to match particular character strings of log messages. Column 702 list six different types of strings that may be found in log messages. Column 704 list six regular expressions that match the character strings listed in column 702. For example, an entry 706 of column 702 represents a format for a date used in the time stamp of many types of log messages. The date is represented with a four-digit year 708, a two-digit month 709, and a two-digit day 710 separated by slashes. The regex 712 includes regular expressions 714-716 separated by slashes. The regular expressions 714-716 match the characters used to represent the year 708, month 709, and day 710. Entry 718 of column 702 represents a general format for internet protocol (“IP”) addresses. A typical general IP address comprises four numbers. Each number ranges from 0 to 999 and each pair of numbers is separated by a period, such as 27.0.15.123. Regex 720 in column 704 matches a general IP address. The regex [θ-9]{1-3} matches a number between 0 and 999. The backslash “\” before each period indicates the period is part of the IP address and is different from the regex symbol “.” used to represent any character. Regex 722 matches any IPv4 address. Regex 724 matches any base-10 number. Regex 726 matches one or more occurrences of a lower-case letter, an upper-case letter, a number between 0 and 9, a period, an underscore, and a hyphen in a character string. Regex 728 matches email addresses. Regex 728 includes the regex 726 after the ampersand symbol.

Regular expressions are designed to match and extract particular strings of characters from log messages. For example, because log messages are unstructured, different types of regular expressions are configured to match and extract particular character strings used to record a date and time in the time stamp portion of a log message.

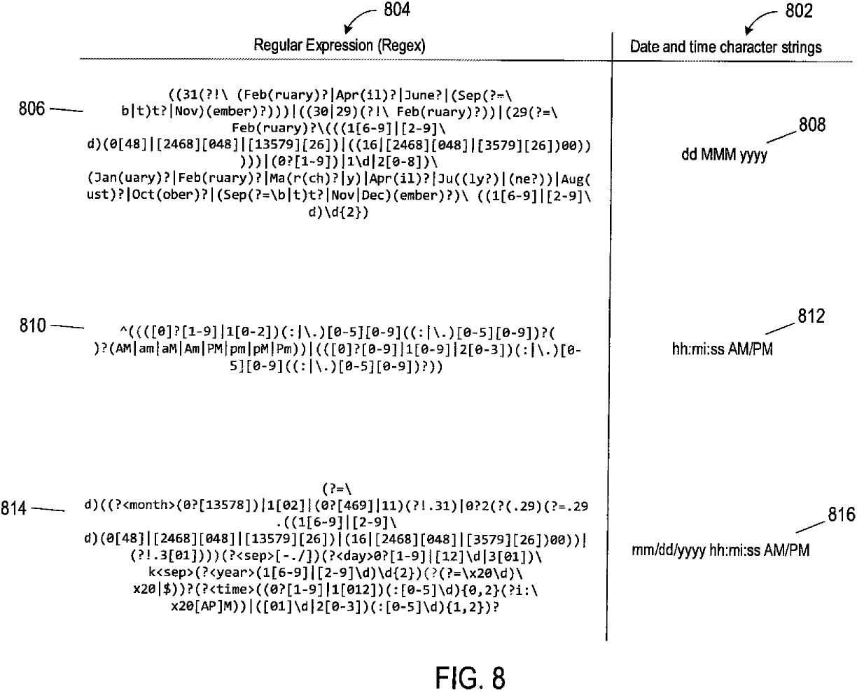

FIG. 8 shows a table of example of date and time formats often used to record the date and time in log messages and corresponding regular expressions that can be used to extract the recorded date and time from log messages. Column 802 displays different formats for representing a date and time in log messages. Column 804 represents regular expressions that match the date and time formats listed in column 802. Regex 806 matches a date with the format 808 in which the month may be recorded in full or using the first three letters. For example, regex 806 matches a date in which the month is written in full, such as 03 Oct. 2020. Regex 806 also matches a date in which the month is abbreviated by the first three letters of the month, such as 29 Feb. 2019. Regular expression 810 matches three different formats for recording time using a twelve or a twenty-four-hour clock represented by a format 812 with a two-digit hour, a two-digit minute, and a two-digit seconds 710 separated by colons followed by am or pm. For example, regex 810 matches a twelve-hour clock time without seconds 6:01 AM, a twelve-hour clock time with seconds 04:27:42 am, or a twenty-four-hour clock time 22:51:11. Regex 814 matches different formats for date and time in which the month, day, hours, and minutes may be represented using single digits. For example, regex 814 matches a date and time format Jan. 31, 2020 and 5:25:23 PM or a date and time format Nov. 5, 2020 and 11:7:23 AM.

In one implementation, the log management server 642 uses Grok patterns to extract tokens from log messages. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax %{Grok pattern}.

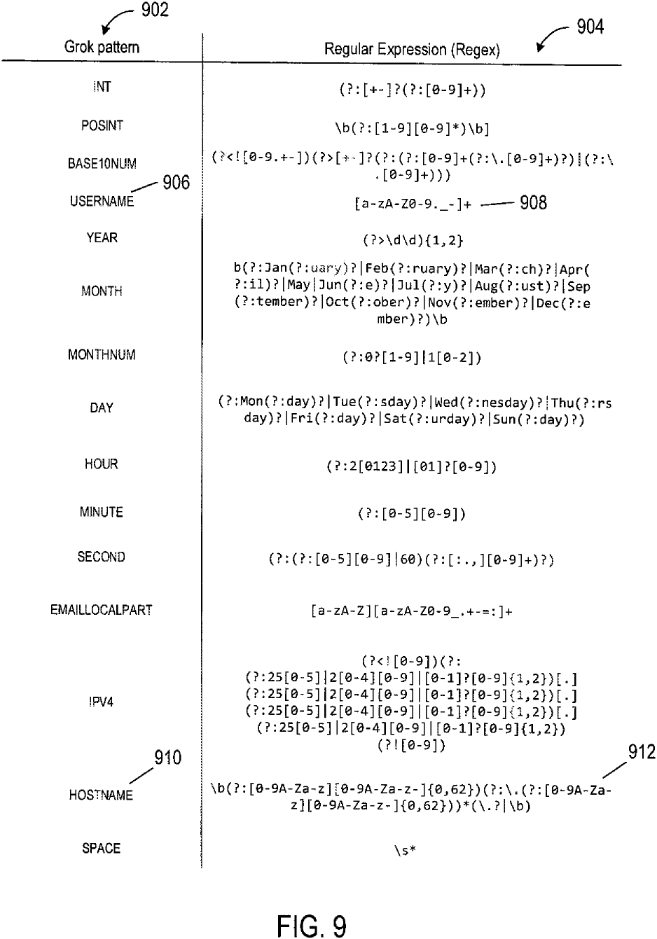

FIG. 9 shows a table of examples of primary Grok patterns and corresponding regular expressions. Column 902 contains a list of primary Grok patterns. Column 904 contains a list of regular expressions represented by the Grok patterns in column 902. For example, the Grok pattern “USERNAME” 906 represents the regex 908 that matches one or more occurrences of a lower-case letter, an upper-case letter, a number between 0 and 9, a period, an underscore, and a hyphen in a character string. Grok pattern “HOSTNAME” 910 represents the regex 912 that matches a hostname. A hostname comprises a sequence of labels that are concatenated with periods. Note that the list of primary Grok patterns shown in FIG. 9 is not an exhaustive list of primary Grok patterns.

A composite Grok pattern comprises two or more primary Grok patterns. Composite Grok patterns may also be formed from combinations of composite Grok patterns and combinations of composite Grok patterns and primary Grok patterns.

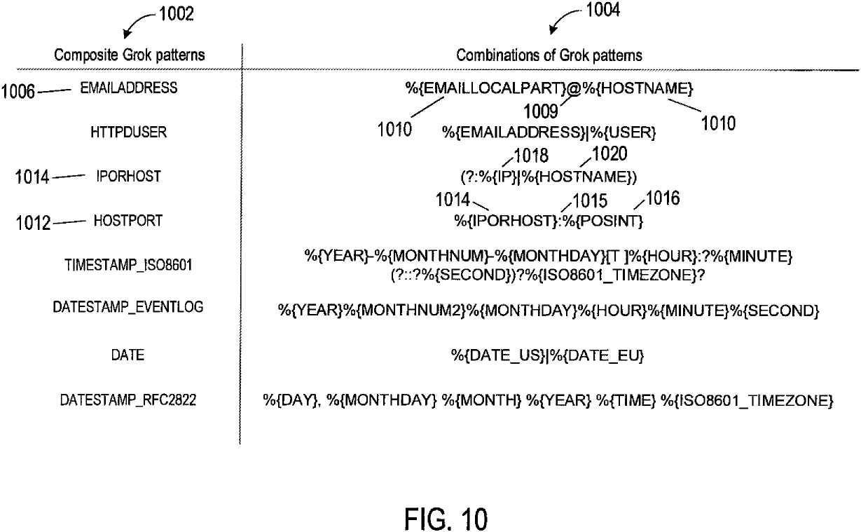

FIG. 10 shows a table of examples of composite Grok patterns. Column 1002 contains a list of composite Grok patterns. Column 1004 contains a list of combinations of Grok patterns that are represented by the Grok patterns in column 1002. For example, composite Grok pattern “EMAILADDRESS” 1006 comprises a combination of “EMAILLOCALPART” 1008, an ampersand 1009, and “HOSTNAME” 1010. The Grok patterns “EMAILLOCALPART” 1008 and “HOSTNAME” 1010 are primary Grok patterns listed in the table shown in FIG. 9. The composite Grok pattern “EMAILADDRESS” 1006 matches the format of nearly any email address. Composite Grok pattern “HOSTPORT” 1012 is a combination of a composite Grok pattern “IPORHOST” 1014, a colon 1015, and a primary Grok pattern “POSINT” 1016. The composite Grok pattern “IPORHOST” 1014 is a composite Grok pattern formed from primary Grok pattern “IP” 1018 and primary Grok pattern “HOSTNAME” 1020. Note that the list of composite Grok patterns shown in FIG. 10 is not an exhaustive list of composite Grok patterns.

Composite Grok patterns also include user defined Grok patterns, such as composite Grok patterns defined by a system administrator or an application owner. User defined Grok patterns may be formed from any combination of composite and/or primary Grok patterns. For example, a user may define a Grok pattern MYCUSTOMPATTERN as the combination of Grok patterns %{TIMESTAMP_lSO8601} and %{HOSTNAME}, where TIMESTAMP__ISO8601 is a composite Grok pattern listed in the table of FIG. 10 and HOSTNAME is a primary Grok pattern listed in the table of FIG. 9.

Grok patterns may be used to map specific character strings into dedicated variable identifiers. Grok syntax for using a Grok pattern to map a character string to a variable identifier is given by:

%{GROK_PATTERN:variable_name}

where
GROK_PATTERN represents a primary or a composite Grok pattern; and
variable_name is a variable identifier assigned to a character string in text data that matches the GROK_PATTERN.

A Grok expression is a parsing expression that is constructed from Grok patterns that match characters strings in text data and may be used to parse character strings of a log message. Consider, for example, the following simple example segment of a log message:

34.5.243.1 GET index.html 14763 0.064

A Grok expression that may be used to parse the example segment is given by:

^%{IP:ip_address}\s%{WORD:word}\s%{URIPATHPARAM:request}\s
%{INT:bytes}\s%{NUMBER:duration}$

The hat symbol “^” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

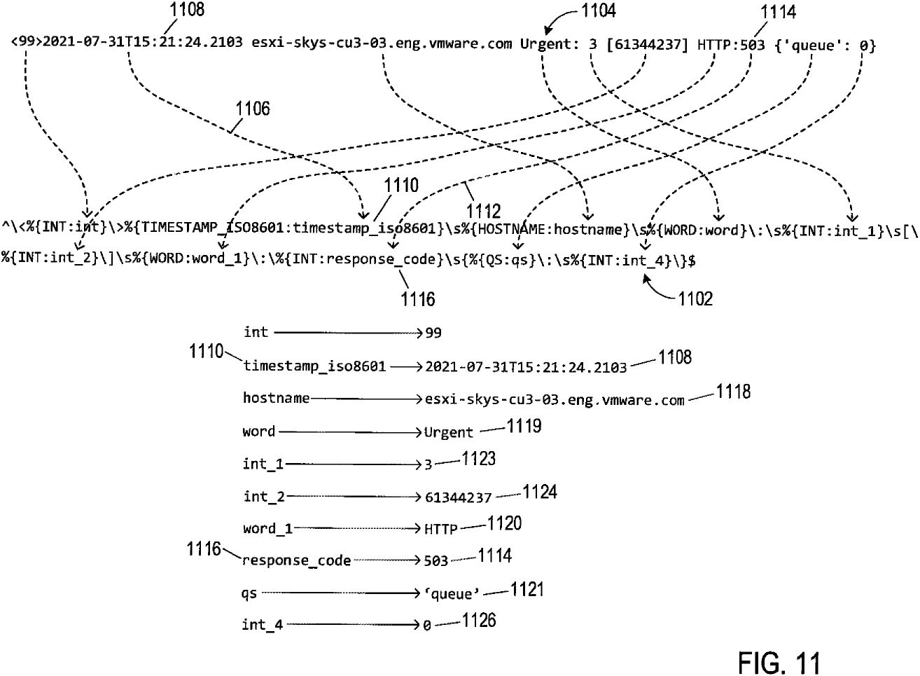

FIG. 11 shows an example of the Grok expression 1102 that parses a log message 1104. Dashed directional arrows represent parsing the log message 1104 such that character strings that correspond to Grok patterns of the Grok expression 1102 are assigned to the corresponding variable identifiers. For example, directional arrow 1106 represents assigning the time stamp 2021-07-31T15:21:24.2103 1108 to the variable identifier timestamp_iso86θ1 1110 and directional arrow 1112 represents assigning the http status code value 503 1114 to the variable identifier response_code 1116. FIG. 11 shows assignments of tokens of the log message 1104 to variable identifiers of the Grok expression 1 102. The combination of non-parametric tokens 1118-1121 identify the event type of the log message 1104. Parametric tokens 1108, 1123, 1124, and 1126 may change for different log messages with the same event type.

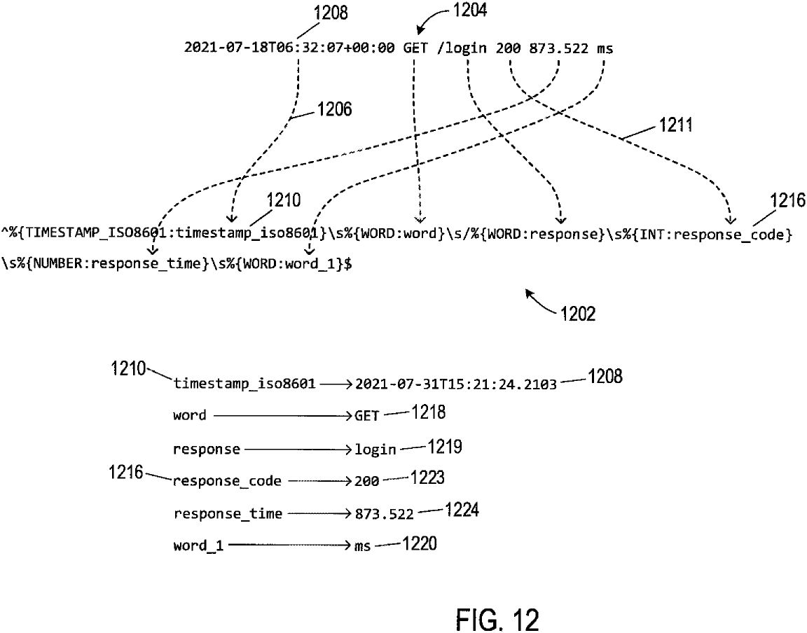

FIG. 12 shows an example of a Grok expression 1202 used to extract tokens from a log message 1204. Dashed directional arrows represent parsing the log message 1204 such that tokens that correspond to Grok patterns of the Grok expression 1202 are assigned to corresponding variable identifiers. For example, dashed directional arrow 1206 represents assigning the time stamp 2021-07-18706:32:07+00:00 1208 to the variable identifier timestamp_iso86θ1 1210 and dashed directional arrow 1212 represents assigning HTTP response code 200 1214 to the variable identifier response_code 1216. FIG. 12 shows assignments of tokens of the log message 1204 to variable identifiers of the Grok expression 1202. The combination of non-parametric tokens 1218-1220 identify the event type of the log message 1204. Parametric tokens 1208, 1223, and 1224 may change for different log messages with the same event type.

### Automated Methods and Systems for Compressing Log Messages

Let L denote an original set of N log messages of a log file with time stamps in a user selected time window [tᵢₙ, t_{fin}]. The log file is stored in a log message database. The log management server 642 partitions the log messages of the original set into log message groups as described below based on the event types of the log messages:

$$L = {g}_{1} ∪ {g}_{2} ∪ … ∪ {g}_{k}$$

where g₁, g₂, ..., gₖ are groups of log messages, called log message groups.

Each log message group contains log messages that belong to the same event type. The subscript k is the number of different event types recorded in the original set of log messages. The event types are denoted by et₁, et₂, ..., etₖ. The log management server 642 counts the number of log messages in each log message group. Let n₁, n₂, ..., nₖ denote the number of log messages in the corresponding log message groups g₁, g₂, ..., gₖ, where N = n₁ + n₂ + ··· + nₖ.

The log management server 642 forms the log messages groups by first using regular expressions or Grok expressions as described above to extract non-parametric tokens from each log message of the original set of log messages. The log management server 642 assigns log messages to log message groups based on the non-parametric tokens extracted from each of the log messages. Log messages with a fraction, or percentage, of matching tokens that is greater than a token matching threshold are identified as having the same event type and belong to the same log message group. Let Th_{match} denote a token matching threshold. The token matching threshold is set to a fraction or percentage. For example, the token matching threshold may be set to 70%, 80%, or 90%. The log management server 642 computes a similarity score for each a pair of log messages (lmₙ, lmₘ) in the original set of log messages:

$${S}_{s c o r e} \left(l {m}_{n} , l {m}_{m}\right) = \frac{{N}_{m a t c h}}{{N}_{t o t a l}} \times 100$$

where
lmₙ denotes the i-th log message in the set L;
lmₘ denotes the j-th log message in the set L;
Nₜₒₜₐₗ is the total number of different non-parametric tokens in the pair of log messages (lmₙ, lmₘ); and
Nₘₐₜ is the number of matching pairs of non-parametric tokens in the pair of log messages (lmₙ, lmₘ).

When the following condition is satisfied for a pair of log messages (lmₙ, lmₘ):

$${S}_{s c o r e} \left(l {m}_{n} , l {m}_{m}\right) \geq T {h}_{m a t c h}$$

the pair of log messages (lmₙ, lmₘ) are identified as having the same event type, etⱼ, and the log messages are assigned to the same corresponding log message group, gⱼ.

Consider, for example, a first log message, lm₁, with a set of tokens {T1,T2,T3,T4,T5,T6} and a second log message, lm₂, with a set of tokens {T1,T2,T3,T4,T5,T7,T8}, where T1, .... T8 represent tokens. The total number of different non-parametric tokens in the two sets of tokens is 8 (i.e., Nₜₒₜₐₗ = 8) and the number of matching pairs of non-parametric tokens is 5 (i.e., N_{matc} = 5). The similarity score is S_{score}(lm₁,lm₂) = 62.5%. For a token matching threshold Th_{match} = 70%, the first and second log messages are not identified as belonging to the same event type (i.e., S_{score}(lm₁, lm₂) < 70%), and therefore, the first and second log messages are not placed in the same log message group. On the other hand, consider again the first log message lm₁ with the set of tokens {T1, T2, T3, T4, T5, T6} and a third log message, lm₃, with a set of tokens {T1, T2, T3, T4, T5, T9}. The total number of different non-parametric tokens in the two sets of tokens is 7 (i.e., Nₜₒₜₐₗ = 7) and the number of matching pairs of non-parametric tokens is 5 (i.e., N_{match} = 5). The similarity score is S_{score}(lm₁, lm₃) = 71.4%. For a token matching threshold set to 70%, the first and third log messages are identified as belonging to the same event type (i.e., S_{score}(lm₁, lm₃) > 70% ), and therefore, the first and third log messages are placed in the same group of log messages.

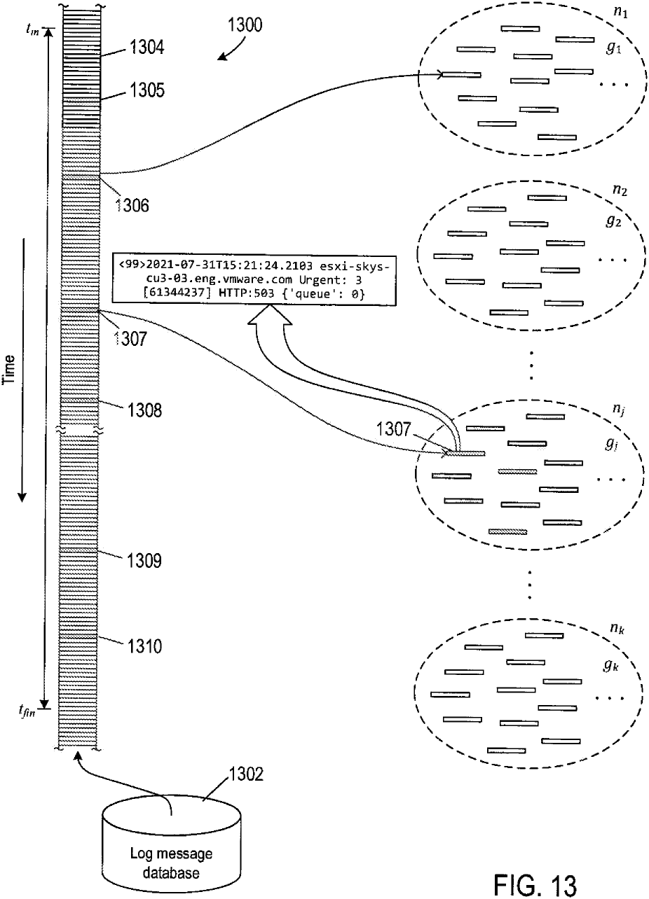

FIG. 13 shows an example of an original set of log messages 1300 of a log file placed into separate groups based on event type. The log file is stored in a log message database 1302. The original set of log messages 1300 contains log messages with time stamps in the time window [tᵢₙ, t_{fin}]. The log management server 642 assigns log messages of the original set of log messages to log message groups g₁, ..., gₖ that are identified by dashed ovals, where the index k is the number of different event types in the original set of log messages. Each log message group contains log messages with similarity scores that are greater than the token matching threshold. For example, shaded rectangles 1304-1310 represent log messages that have similarity scores that are greater than the token matching threshold. As a result, the log messages 1304-1310 have the same event type etⱼ and belong to the log message group gⱼ. In this example, the log message 1307 corresponds to the log message 1104 in FIG. 11. The log messages in the log message group gⱼ contain the non-parametric tokens 1118-1121 that represent the event type etⱼ described above with reference to FIG. 11. The log messages in the log message group gⱼ may have different parametric tokens and may differ in certain non-parametric tokens, but the similarity scores of all pairs of log messages in the log message group gⱼ are greater than the token matching threshold. For the sake of brevity, ellipses, such as ellipsis 1312, represent log messages that are not shown. The log management server 642 counts the number of log messages in each log message group. The number of log messages in each of the log message groups are denoted by denoted by n₁,..., nₖ.

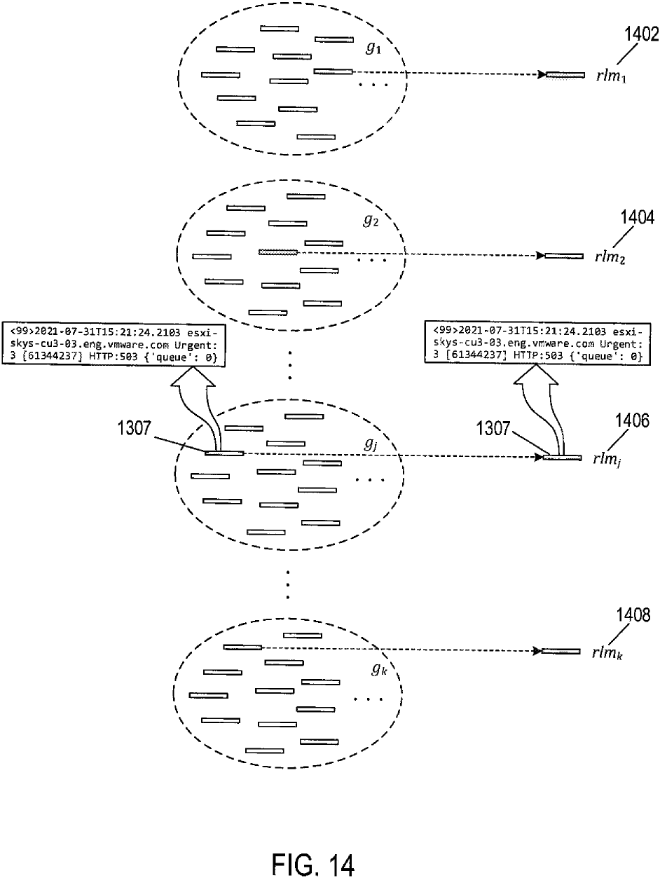

The log management server 642 determines a representative log message for each of the log message groups. The representative log messages of the log message groups g₁, ...,gₖ are denoted by rlm₁, ..., rlmₖ, respectively. Each representative log message is a member of a corresponding log message group and best represents the log messages in the log message group. FIG. 14 shows examples of representative log messages associated with the log message groups g₁,...,gₖ. Representative log message rlm₁ 1402 is a member of the log message group g₁, representative log message rlm₂ 1404 is a member of the log message group g₂, representative log message rlmⱼ 1406 is a member of the log message group gⱼ, and representative log message rlmₖ 1408 is a member of the log message group gₖ. In this example, the log message 1307 is the representative log message 1406 for the group gⱼ.

The representative log messages are determined using one of a number of different techniques described below. In one implementation, for each log message group, the log management server 642 computes an average similarity score for each log message and identifies the log message with the largest average similarity score as the representative log message for the log message group. For example, the log management server 642 computes an average similarity score for each log message in the j-th log message group gⱼ as follows:

$$A v e \_ {S}_{s c o r e} \left(l {m}_{i}\right) = \frac{1}{{n}_{j} - 1} {\sum }_{\begin{matrix}m = 1 \\ m \neq i\end{matrix}}^{{n}_{j} - 1} {S}_{s c o r e} \left(l {m}_{i} , l {m}_{m}\right)$$

where
nⱼ is the number of log messages in the log message group gⱼ;
i = 1, ..., nⱼ.

The largest average similarity score is given by

$$A v e \_ {S}_{s c o r e} \left(l {m}_{q}\right) = m a x \left\{A v e \_ {S}_{s c o r e} \left(l {m}_{1}\right) , … , A v e \_ {S}_{s c o r e} \left(l {m}_{{n}_{j}}\right)\right\}$$

where q ∈ {1,...,nⱼ}.

The log management server 642 identifies the log message lm_{q} as the representative log message, rlmⱼ, for the log message group gⱼ.

In another implementation, for each log message group, the log management server 642 designates the log message with the largest similarity score as the representative log message for the log message group. For example, the log management server 642 identifies the largest similarity score S_{score}(lmₙ, lmₘ) of the log messages in the j-th log message group gⱼ. The log management server 642 identifies either the log message lmₙ or the log message lmₘ as the representative log message, rlmⱼ,

In still another implementation, for each log message group, the log management server 642 designates the log message with the largest number of similarity scores that are greater than a degree threshold, Th_{deg}, as the representative log message for the log message group. The following pseudocode determines the representative log message of the j-th log message group gⱼ as follows:

1 For i = 1, ..., nⱼ { //for log message group gⱼ
2 Initialize count(lmᵢ) = 0; //counter of similarity scores greater Th_{deg}
3 For s = 1,..., nⱼ and s ≠ i {
4 If S_{score}(lmᵢ, lmₛ) > Th_{deg}
5 count(lmᵢ) + +;
6 }
7 }
8 count(lm_{q}) = max {count(lm₁), ..., count (lm_{nⱼ} )}:
9 Set rlmⱼ = lm_{q}; //sets representative log message to log message with largest counter

The log management server 642 performs lossy compression of the original set of log messages by first replacing, or overwriting, the log messages in the original set of log messages with representative log messages that correspond to the log message groups to obtain a lossy set of log messages. The lossy set of log messages contains only the representative log messages of the different log message groups (i.e., different event types). Overwriting the log messages in the original set of log messages with corresponding representative log messages creates information loss because information represented by parametric tokens and certain non-parametric tokens in the log messages of the original set of log messages is not contained in the representative log messages of the lossy set of log messages. The log management server 642 then uses a source coding technique as described below to compress (e.g., overwrite) the representative log messages in the lossy set of log messages into variable-length binary codewords to obtain a lossy compressed set of log messages. The original set of log messages is deleted from the log message database.

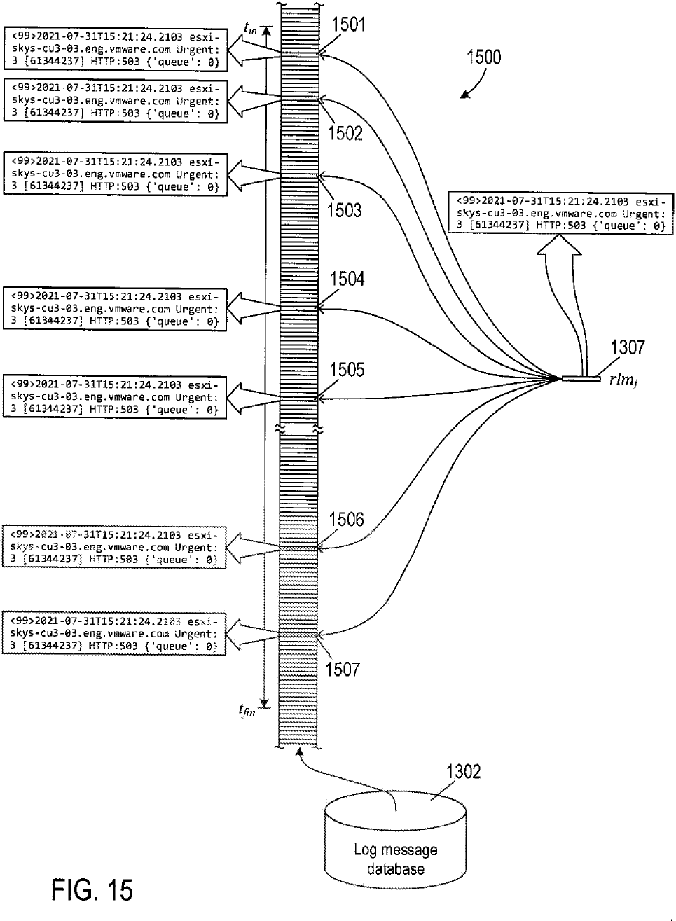

FIG. 15 shows an example of a lossy set of log messages 1500 obtained by replacing the log messages of the original set of log messages 1300 with corresponding replacement log messages. In the example of FIG. 15, the log messages 1305-1310 of the original set of log messages 1300 in FIG. 13 are overwritten by the single representative log message 1307 for the corresponding log message group gⱼ. Shaded rectangles 1501-1507 represent locations in the log file where the log messages 1305-1310 that have been overwritten by the single representative log message 1307. Log messages 1501-1507 are enlarged to reveal that the log messages 1305-1310 of FIG. 13 contain the single representative log message 1307.

The log management server 642 performs source coding by computing a probability distribution of the k different event types associated with the log message groups g₁, ..., gₖ. The probability distribution for the original set of log messages is given by

$$P = \left({p}_{1} , … , {p}_{k}\right)$$

where

$${p}_{j} = \frac{{n}_{j}}{N}$$

for j = 1, ...,nⱼ.

The quantity pⱼ is the probability (i.e., 0 ≤ pⱼ < 1) that a randomly selected log message of the original set of log messages belongs to the log message group gⱼ. In other words, the quantity pⱼ is the probability that a randomly selected log message of the original set of log messages has the event type etⱼ. The log management server 642 orders the probabilities of the probability distribution P from largest to smallest (or alternatively from smallest to largest) to obtain an ordered probability distribution.

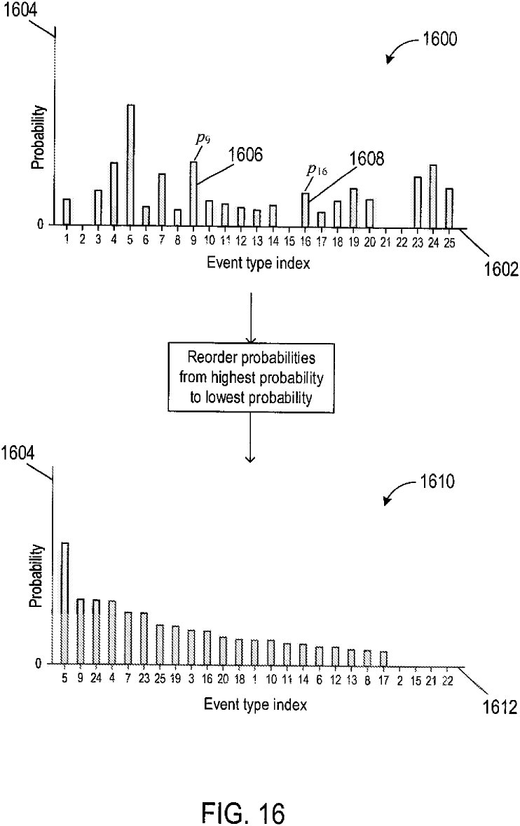

FIG. 16 shows a plot of an example probability distribution 1600. Horizontal axis 1602 represents event type index. Vertical axis 1604 represents a range of probabilities. Bars represent the probabilities associated with each of the event types of the log message groups. In this example, there are 25 different event types (i.e., k = 25) that correspond to 25 log message groups. For example, bar 1606 represents the probability p₉ of the 9th event type and bar 1608 represents the probability p₁₆ of the 16th event type. FIG. 16 shows a plot of an ordered probability distribution 1610 obtained from ordering the probabilities of the probability distribution 1600 from the largest probability to the smallest probability. Horizontal axis 1612 represents the event type indices associated with the probabilities of the ordered probability distribution.

In one implementation, the log management server 642 performs source coding by constructing a source coding tree based on the ordered probability distribution. The source coding tree ensures that the higher probability event types (i.e., more frequently occurring event types) have the shortest corresponding codewords while the lower probability event types (i.e., less frequently occurring event types) have the longest corresponding codewords.

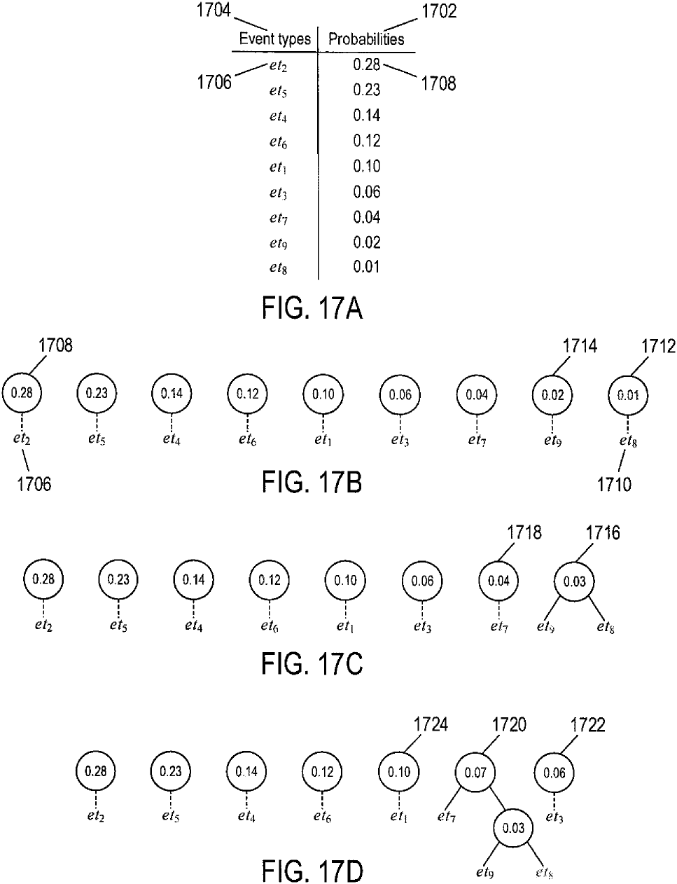

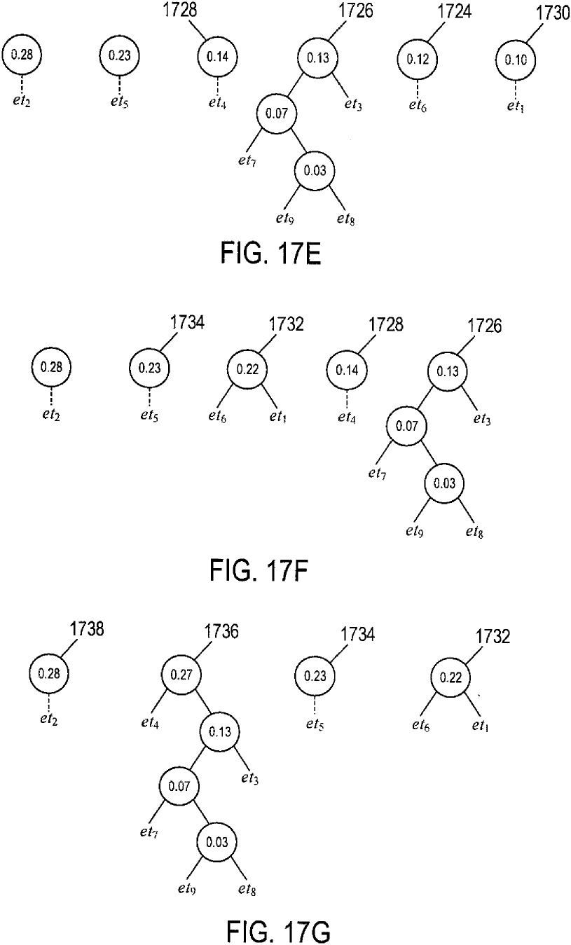

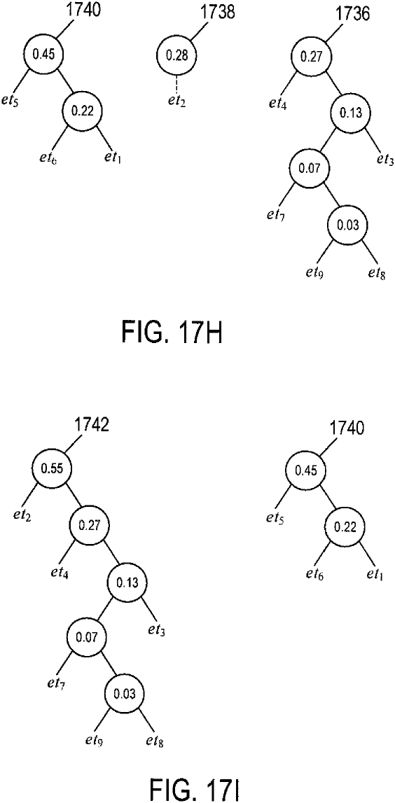

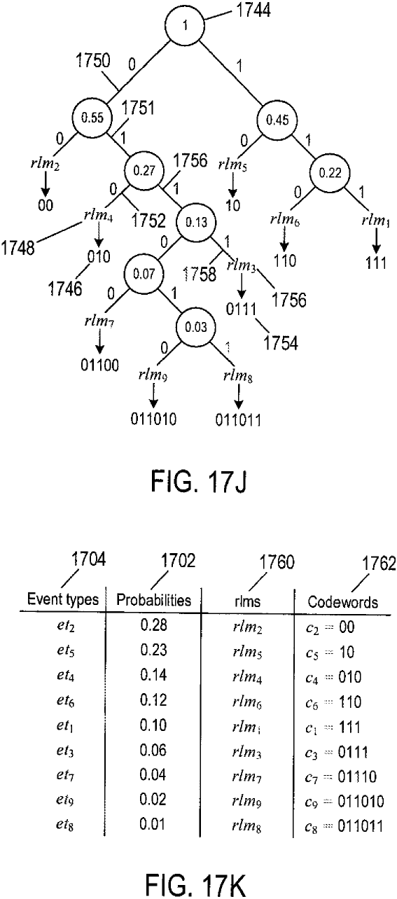

FIGS. 17A-17K show an example of constructing a source coding tree based on an example ordered probability distribution. It should be noted at the outset that for the sake of simplicity in describing the process of constructing a source coding tree a small number of event types (i.e., k = 9) has been selected. In practice, the actual number of event types can be in the thousands and even the millions and construction the source coding tree is automated.

FIG. 17A shows an example of probabilities of an ordered probability distribution associated with event types. Column 1702 list the probabilities of the ordered probability distribution. Column 1704 list the event types associated with the ordered probabilities in column 1702. Each event type is associated with a log message group of a set of log messages and is in turn associated with a representative log message as described above. For example, event type et₂ 1706 has a corresponding probability of 0.28 1708. In other words, twenty-eight percent of the log messages in the original set of log messages have the event type et₂ 1706. The log messages with the event type et₂ form a log message group g₂ and have a representative log message rlm₂.

FIGS. 17B-17J show stages in construction of a simple source coding tree based on the nine event types listed in FIG. 17A. The event types are leaf nodes of the source coding tree. The non-leaf nodes of the source coding tree represent probabilities. At each stage of source coding tree construction, the nodes with the two smallest probabilities are added together to create a new node with an associated probability. The new node is inserted into the probability ordering of the nodes and the process is repeated. Source coding tree construction stops when a root node with probability 1 is formed.

FIG. 17B shows a first stage in which the probabilities represented by nodes and associated event types in FIG. 17A are arranged from largest to smallest. At this stage, the probabilities are represented by nodes that have not yet been combined to form the source coding tree. For example, event type et₂ 1706 is a leaf node associated with the largest probability represented by node 1708 and event type et₈ 1710 is a leaf node associated with the smallest probability represented by node 1712. In FIG. 17C, the two smallest probabilities 1712 and 1714 are added together to create a node 1716 of the source coding tree. Because the probability of the node 1716 represents the smallest probability, the node 1716 remains at the end of the ordered nodes. In FIG. 17D, the two smallest probabilities 1716 and 1718 are added together to obtain a node 1720. Because the probability of the node 1720 represents the second smallest probability, the node 1720 is inserted between the nodes 1722 and 1724. In FIG. 17E, the two smallest probabilities 1720 and 1722 are added together to obtain the node 1726 which has been inserted between the nodes 1724 and 1728 because the probability of node 1726 is between the probabilities represented by nodes 1724 and 1728. In FIG. 17F, the two smallest probabilities 1724 and 1730 are added together to obtain the node 1732 which has been inserted between the nodes 1728 and 1734 because the probability of node 1732 is between the probabilities represented by nodes 1728 and 1734. In FIG. 17G, the two smallest probabilities 1726 and 1728 are added together to obtain the node 1736 which has been inserted between the nodes 1732 and 1738 because the probability of node 1736 is between the probabilities represented by nodes 1734 and 1738. In FIG. 17H, the two smallest probabilities 1732 and 1734 are added together to obtain the node 1740 which has been inserted before the node 1738 because the probability represented by node 1740 is greater than the probability represented by node 1738. In FIG. 17I, the two smallest probabilities 1736 and 1738 are added together to obtain the node 1742 which has been inserted before the node 1740 because the probability represented by node 1742 is greater than the probability represented by node 1740.

FIG. 17J shows an example source coding tree obtained from adding the probabilities 1740 and 1742 together to obtain a root node 1744. The pair of edges connecting a parent node to two adjacent child nodes are labeled with binary digits “0” and “1.” In this implementation, the left-hand edge extending from a parent node is labeled with a value “0” and the right-hand edge extending from the node is labeled with value “1.” In another implementation, the right-hand edge extending from a node is labeled with value “0” and the left-hand edge extending from the node is labeled with value “1.” The event types at the leaves have been replaced by the corresponding replacement log messages. For example, leaf event type et₂ in FIGS. 17B-17I has been replaced by corresponding replacement log message rlm₂. A codeword is obtained for each replacement log message by traversing the edges of the source coding tree from the root node 1744 to a leaf node and sequentially appending the binary digits of each edge. For example, the codeword “010” 1746 for the replacement log message rlm₄ 1748 is obtained by appending the binary digits that correspond to the path edges 1750-1752. As another example, the codeword “0111” 1754 of the replacement log message rlm₃ 1756 is obtained by traversing the path edges 1750, 1751, 1756, and 1758 and appending the corresponding binary digits.

FIG. 17K shows a source coding table of the event types 1704 and associated probabilities 1702 of FIG. 17A and includes a column 1760 of replacement log messages and a column 1762 of codewords. Note that the size of the codeword decreases with an increase in probability of the event types. For example, the highest probability (i.e., most frequently occurring) event type et₂ has the shortest codeword “00” and the lowest probability (i.e., least frequently occurring) event type et₈ has the longest codeword “011011.”

In another implementation, the log management server 642 constructs variable length codes as an iterative process of partitioning the ordered probability distribution into subsets with total probabilities that are the closest to being equal. The process proceeds by arranging the probabilities of the event types in order from most probable to least probable. The ordered probabilities are partitioned into two parent subsets whose total probabilities are as close as possible to being equal. A codeword for one subset is started with the value “0,” and a codeword for the other subset is started with the value “1.” Each parent subset having more than one event type is partitioned into two child subsets whose total probabilities are as close as possible to being equal. A codeword is obtained for one child subset by appending the value “0” to the codeword of the parent subset. A codeword is obtained for the other child subset by appending the value “1” to the codeword of the parent subset. This process is repeated until only subsets with one event type remain.

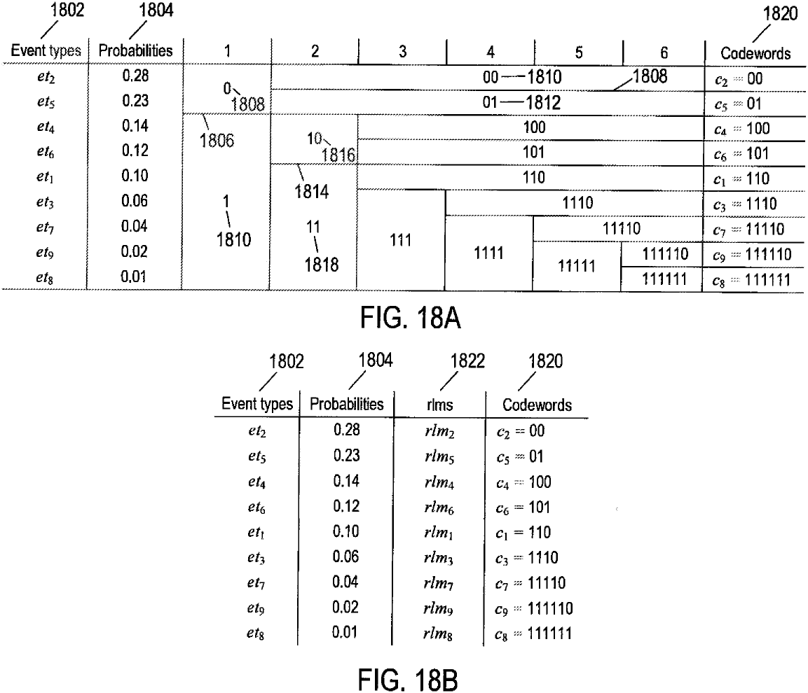

FIG. 18A shows an example table that represents an iterative process of constructing variable length codewords for the nine event types listed in column 1802 and associated probabilities listed in column 1804. The event types and probabilities correspond to the event types and probabilities listed in the table of FIG. 17A. At iteration “1.” line 1806 represents partitioning the event types into two subsets such that the sum of the probabilities of one subset {et₂, et₅} is 0.51 and the sum of the probabilities of the other subset {et_{4,} et₆, et₁, et₃, et₇, et₉, et₈} is 0.49, which are the closest nearly equal probabilities. The value “0” 1808 is assigned to the subset {et₂,et₅} and the value “1” 1810 is assigned to the subset {et_{4,} et₆, et₁, et₃, et₇, et₉, et₈}. At iteration “2,” line 1808 represents partitioning the subset {et₂,et₅} into two single element subsets {et₂} and {et₅}. A codeword “00” 1810 is obtained for the subset {et₂} by adding the value “0” to the value “0” 1808. and a codeword “00” 1812 is obtained for the subset {et₅} by adding the value “1” to the value “0” 1808. At iteration “2,” line 1814 represents partitioning the subset {et4, et₆, et₁, et₃, et₇, et₉, et₈} into the subset {et_{4,} et₆} with a probability 0.26 and a subset {et₁, et₃, et₇, et₉, et₈} with a probability 0.23, which are the closest nearly equal probabilities. A codeword “10” 1816 is obtained for the subset {et_{4,} et₆} by adding the value “0” to the value “1” 1810, and a codeword “11” 1818 is obtained for the subset {et₁, et₃, et₇, et₉, et₈} by adding the value “1” to the value “1” 1810. The process of partitioning the subset of event types based on nearly equal associated probabilities is repeated until codewords are obtained in column 1820. Like the variable length codewords obtained in FIG. 17K, the size of the codewords in column 1820 decreases with an increasing probability of the event types.

FIG. 18B shows a source coding table of the event types 1802 and associated probabilities 1804 and includes a column 1822 of replacement log messages and a column 1820 of codewords. The replacement log messages listed in column 1822 correspond to the event types listed in column 1802.

The log management server 642 uses source coding as described above with reference to FIGS. 17A-17K or FIGS. 18A-18B to generate a codeword for each representative log message of the lossy set of log messages. The log management server 642 compresses the replacement log messages in the lossy set of log messages by overwriting the replacement log messages with the corresponding codewords to obtain a lossy compressed set of log messages.

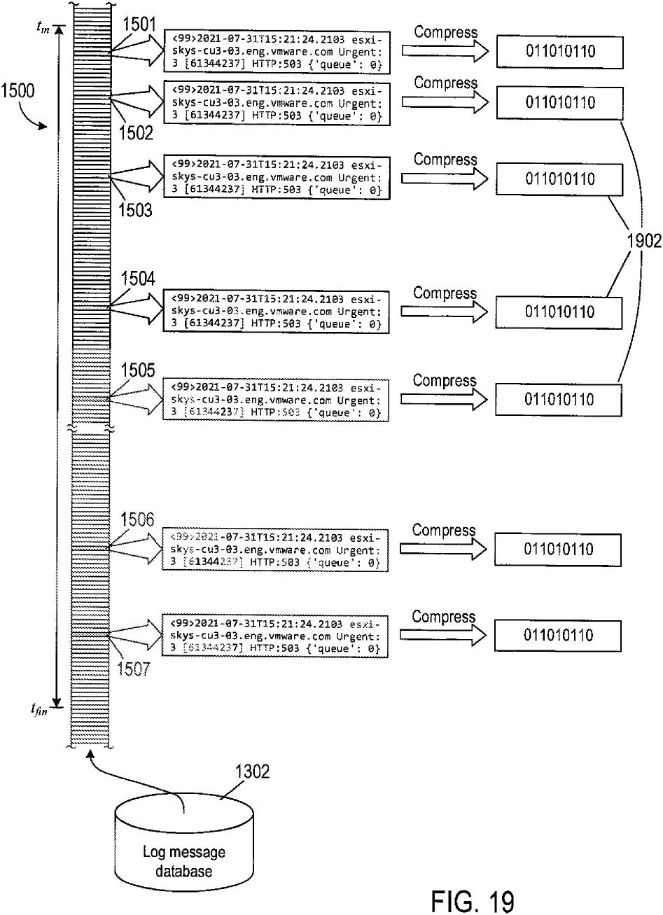

FIG. 19 shows an example of compressing the representative log messages of the lossy set of log messages 1500 into corresponding codewords. As described above with reference to FIG. 15, representative log messages 1501-1507 are identical. In this example, source coding has generated a codeword “011010110” that corresponds to the replacement log messages 1501-1507. In FIG. 19, enlarged views of the representative log messages 1501-1507 are compressed by overwriting every occurrence of the representative log messages 1501-1507 with the same codeword “011010110” 1902. Although not shown for the sake of brevity, other representative log messages of the lossy set of log messages 1500 are compressed by overwriting the representative log messages with corresponding codewords. More frequently occurring representative log messages are overwritten with shorter codewords than less frequently occurring representative log messages.

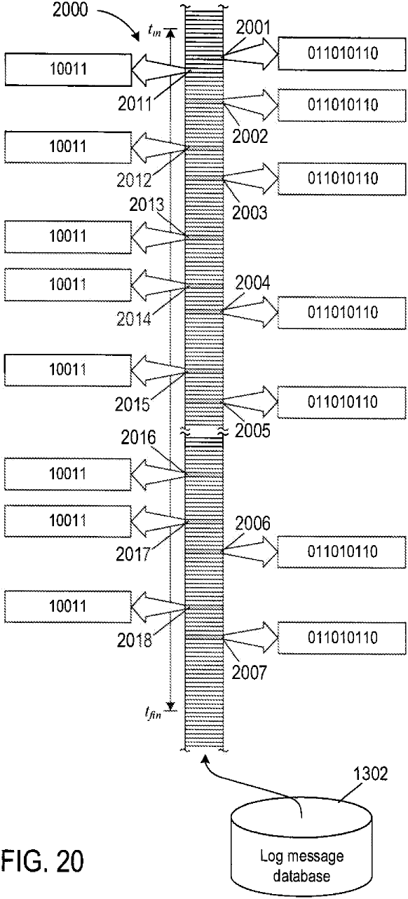

FIG. 20 shows an example of a lossy compressed set of log messages 2000. The lossy compressed set of log messages 2000 has been produced by overwriting the identical representative log messages 1501-1507 of the lossy set of log messages 1500 with the identical codewords 2001-2001. FIG. 20 also shows a different set of more frequently occurring representative log message overwritten by identical codeword “10011” 2011-2018. Note that codeword “10011” is shorter than the codeword “011010110” because the representative log message associated with the codeword “10011” occurs with a higher probability (i.e., more frequent) than the representative log message associated with the codeword “01010110.”

Log messages are typically stored in a data storage appliance as a continuous string of 8-bit ASCII codewords (“American Standard Code for Information Interchange”). In other words, each character of a log message requires 8 bits of data storage. For example, storage of a log message that contains 200 characters requires 1600 bits. By contrast, compression of the representative log messages of a lossy set of log messages into codewords as described above, eliminates use of the ASCII codewords to store each character of the log messages. Instead, each representative log message is stored as a binary codeword that is much shorter than the corresponding ASCII encoded log message. As a result, a lossy compressed set of log messages obtained as described above occupies far less storage space than the original or lossy set of log messages.

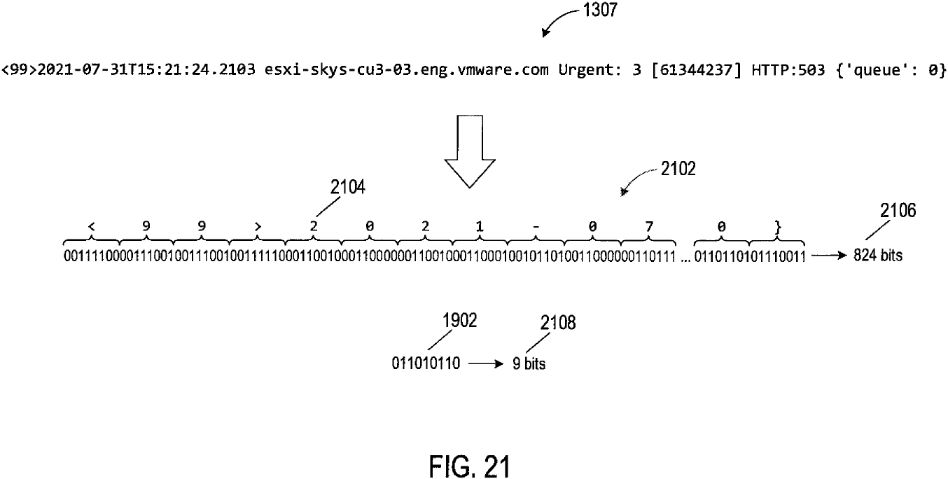

FIG. 21 shows the representative log message 1307 and the corresponding codeword 1902 described above. FIG. 21 also shows a small portion of the ASCII code 2102 used to store the log message 1307 in a log message database. For example, the character “2” 2104 is stored with the ASCII codeword “00110010.” Because the representative log message 1307 contains 103 characters, simply storing one occurrence of the representative log message 1307 in the lossy set of log messages requires 824 bits 2106. If the representative log message 1307 is repeated 100 times in the lossy set of log messages, the repeated occurrences of the representative log message 1307 requires 82.400 bits of storage space. By contrast, the codeword 1902 that overwrites the representative log message 1307 lossy compressed set of log messages only requires 9 bits 2108 for data storage. Replacement of the 100 incidents of the representative log message 1307 by the corresponding codeword 1902 requires only 900 bits, which is a 98% reduction in the amount storage needed just to store the repeated incidents of the replacement log message 1307.

The log management server 642 discards the original set of log messages and stores the lossy compressed set of log messages and a source coding tree, or a source coding table, in a log message database. When a user request to view the compressed log messages in a display or process the log messages in a search for anomalous behavior, the log management server 642 retrieves the lossy compressed set of log messages and the corresponding source coding tree, or source coding table, from the log messages database and uses the source coding tree or table to decompress each of the codewords of the lossy compressed set of log messages and recover the representative log messages of the lossy set of log messages.

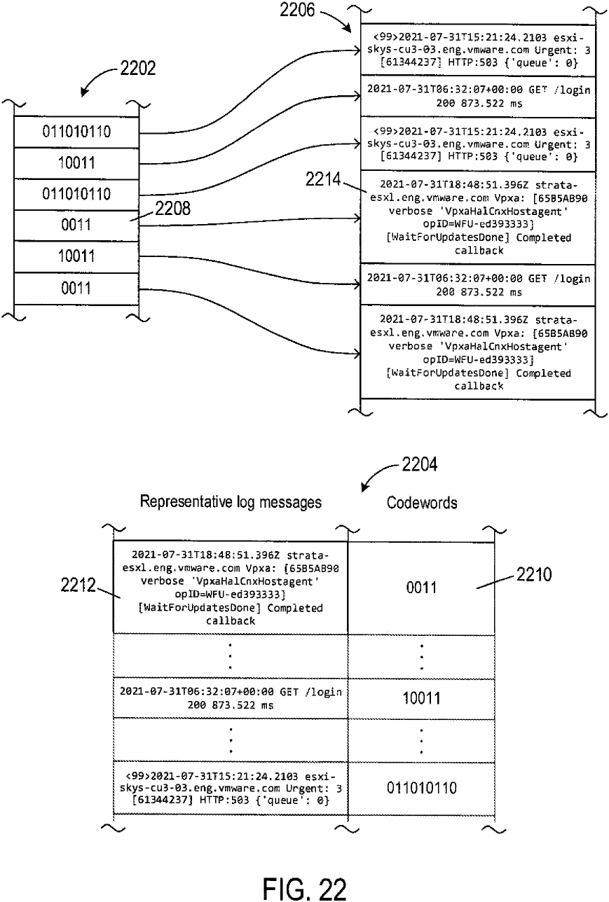

FIG. 22 shows an example portion of a lossy compressed set of log messages 2202 and a source coding table 2204 that has been used to compress representative log messages into the lossy compressed set of log messages 2202. The lossy compressed set of log messages 2202 and the source coding table 2204 are stored in a log message database. When a request by a systems administrator, or other user, is made to recover the lossy set of log messages for log message analysis, the log management server 642 uses the source coding table 2204 to decode (i.e., decompress) the lossy compressed set of log messages 2202 and obtain the lossy set of log messages. FIG. 22 shows an example portion of a lossy set of log messages 2206 that correspond to the portion of lossy compressed set of log messages 2202. The lossy set of log messages 2206 is obtained by decoding the lossy compressed set of log messages 2202 using the source coding table 2204. For example, codeword 2208 in the lossy compressed set of log messages 2202 corresponds to the same codeword 2210 in the source coding table 2204 and corresponding representative log message 2212 is added to the lossy set of log messages 2206 as entry 2214.

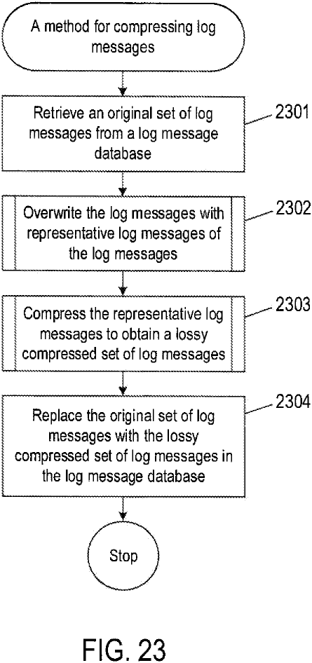

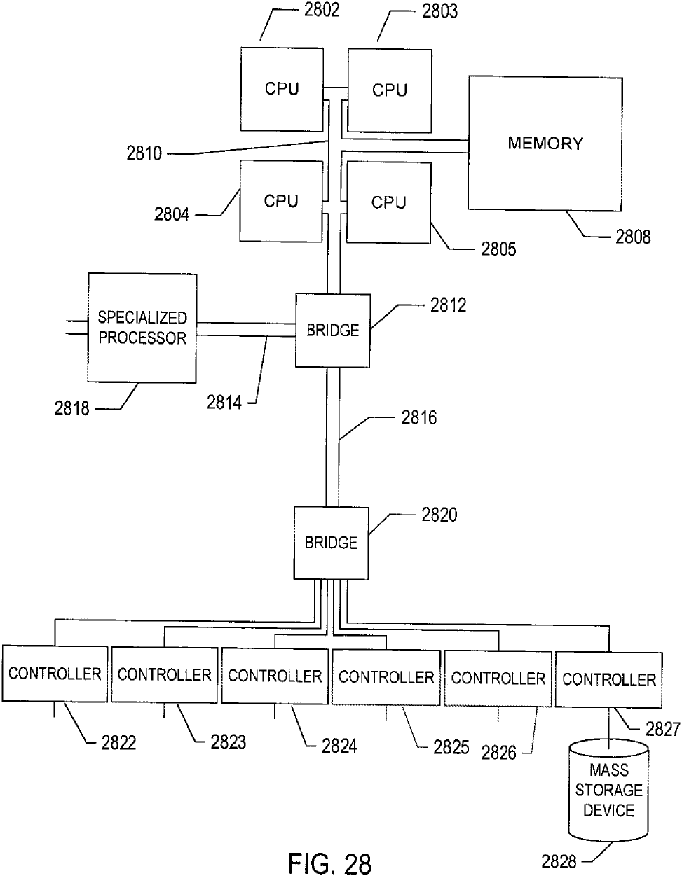

The computer-implemented methods described below with reference to FIGS. 23-27 are stored in one or more data-storage devices as machine-readable instructions that when executed by one or more processors of the computer system, such as the computer system described below with reference to FIG. 28, compress log messages stored in a log message database.

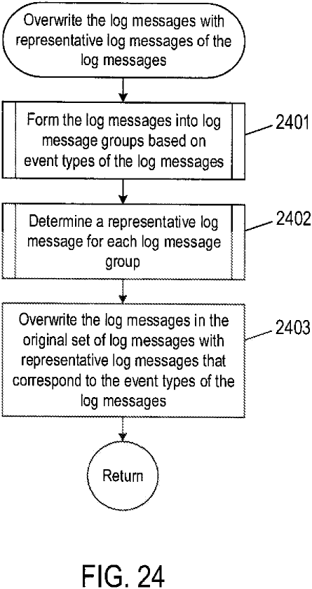

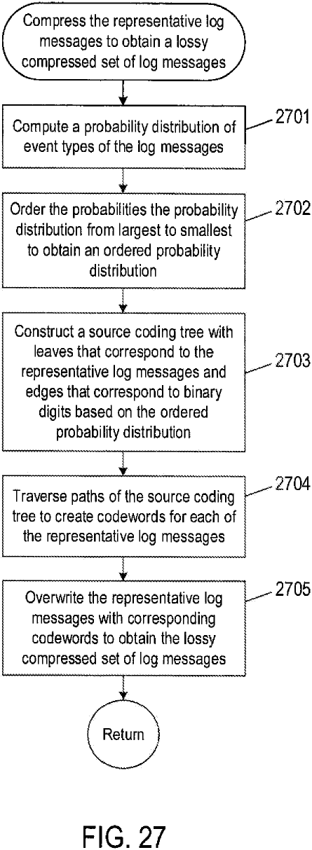

FIG. 23 is a flow diagram illustrating an example implementation of a “method for compressing log messages.” In block 2301, an original set of log messages are retrieved from a log message database. In block 2302, an “overwrite the log messages with representative log messages of the log messages” process is performed. An example implementation of the “overwrite the log messages with representative log messages of the log messages” process is described below with reference to FIG. 24. In block 2303, an “compress the representative log message to obtain a lossy compressed set of log messages” process is performed. An example implementation of the “compress the representative log message to obtain a lossy compressed set of log messages” process is described below with reference to FIG. 27. In block 2304, the original set of log messages are replaced with the lossy compressed set of log messages in the log message database.

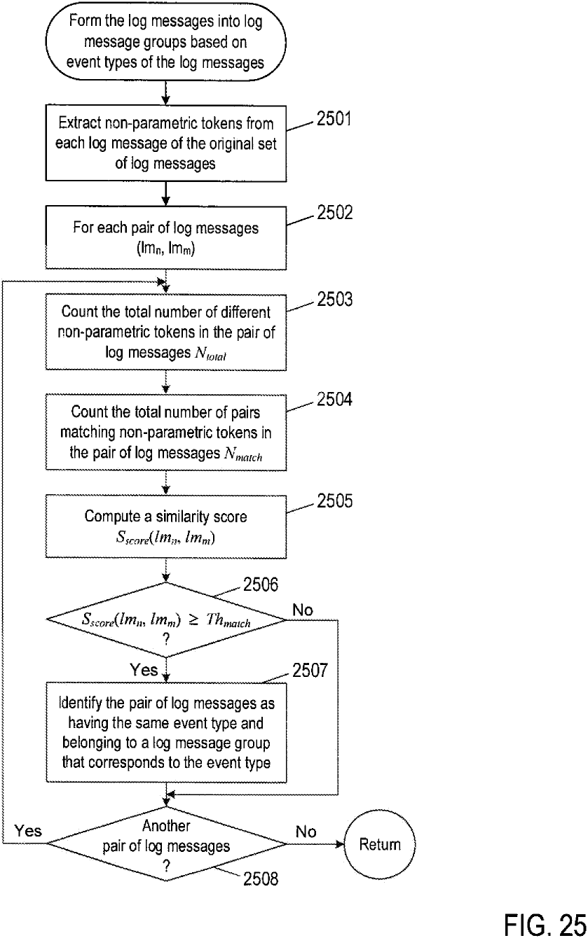

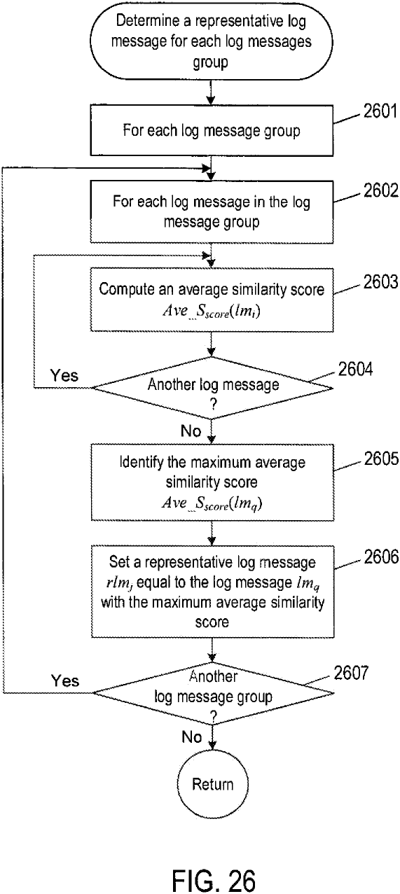

FIG. 24 is a flow diagram of the “overwrite the log messages with representative log messages of the log messages” process performed in block 2302 of FIG. 23. In block 2401, a “form the log messages into the log message groups based on event types of the log message” process is performed. An example implementation of the “form the log messages into the log message groups based on event types of the log message” process is described below with reference to FIG. 25. In block 2402, a “determine a representative log message for each log message group” process is performed. An example implementation of the “determine a representative log message for each log message group” process is described below with reference to FIG. 26. In block 2403, the log messages in the original set of log messages are overwritten with representative log messages obtained in block 2402.

FIG. 25 is a flow diagram of the “form the log messages into the log message groups based on event types of the log message” process performed in block 2401 of FIG. 24. In block 2501, non-parametric tokens are extracted from each log message of the original set of log messages as described above with reference to FIGS. 11 and 12. A loop beginning with block 2502 repeats the operations represented by blocks 2503-2507. In block 2503, a total number of different non-parametric tokens in the pair of log messages is counted as described above with reference to FIG. (2). In block 2504, a total number of pairs matching non-parametric tokens in the pair of log messages is counted as described above with reference to FIG. (2). In block 2505, a similarity score is computed as described above with reference to Equation (2). In decision block 2506, when the similarity score computed in block 2505 is greater than a token matching threshold the process flow to block 2507. In block 2507, the pair of log messages is identified as the same event type and belonging to a log message group that corresponds to the event type. In decision block 2708, the operations represented by blocks 2503-2507 are repeated for another pair of log messages.

FIG. 26 is a flow diagram of the “determine a representative log message for each log message group” process performed in block 2402 of FIG. 24. A loop beginning with block 2601 repeats the operations represented by blocks 2602-2607 for each log message group. A loop beginning with block 2602 repeats the operation represented by block 2603 for each log message. In block 2603, an average similarity score is computed as described above with reference to Equation (4) based on the similarity scores computed in block 2505 of FIG. 25. In decision block 2604, the average similarity score is computed for another log message. In block 2605, a maximum average similarity is identified as described above with reference to Equation (5). In block 2606, a representative log message is set equal to the log message with maximum average similarity score identified in block 2605. In decision block 2607. the operations represented by blocks 2602-2606 are repeated for another log message group.

FIG. 27 is a flow diagram of the “compress the representative log message to obtain a lossy compressed set of log messages” process performed in block 2304 of FIG. 23. In block 2701, a probability distribution of event types of the log messages in the original set of log messages is computed. In block 2702, the probabilities of the probability distribution ordered from largest to smallest to obtain an ordered probability distribution as described above with reference to FIG. 16. In block 2703, a source coding tree is constructed with leaves that correspond to the representative log messages and edges that correspond to binary digits based on the ordered probability distribution as described above with reference to FIGS. 17B-17J. In block 2704, paths of the source coding tree are traversed to create codewords for each of the representative log messages as described above with reference to FIG. 17J. In block 2705, the representative log messages are overwritten with corresponding codewords to obtain the lossy compressed set of log messages.

FIG. 28 shows an example architecture of a computer system that may be used to host the log management server 642 and perform the operations that compress log messages as described above. The computer system contains one or multiple central processing units (“CPUs”) 2802-2805, one or more electronic memories 2808 interconnected with the CPUs by a CPU/memory-subsystem bus 2810 or multiple busses, a first bridge 2812 that interconnects the CPU/memory-subsystem bus 2810 with additional busses 2814 and 2816, or other types of high-speed interconnection media, including multiple, high-speed serial interconnects. The busses or serial interconnections, in turn, connect the CPUs and memory with specialized processors, such as a graphics processor 2818, and with one or more additional bridges 2820, which are interconnected with high-speed serial links or with multiple controllers 2822-2827, such as controller 2827, that provide access to various different types of computer-readable media, such as computer-readable medium 2828, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 2828 is a data-storage device, which may include, for example, electronic memory, optical or magnetic disk drive, a magnetic tape drive, USB drive, flash memory and any other such data-storage device or devices. The computer-readable medium 2828 is used to store machine-readable instructions that encode the computational methods described above.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for compressing log messages stored in a log file of a log message database, the method comprising:
overwriting the log messages with representative log messages of the log messages:
compressing the representative log messages into codewords to obtain a lossy compressed set of log messages; and
replacing the original set in the log message database with the lossy compressed set.

2. The method of claim 1 wherein overwriting the log messages with representative log messages comprises:
forming the log messages into log message groups based on event types of the log messages:
determining a representative log message for each log message group, each representative log message corresponding to an event type of the log messages; and
overwriting the log messages of the original set with representative log messages that correspond to the event types of the log messages.

3. The method of claim 2 wherein forming the log messages into log messages groups comprises:
extracting non-parametric tokens from the log messages using regular expressions or Grok expressions;
for each pair of log messages,
counting the total number of different non-parametric tokens in the pair of log messages,
counting the total number of pairs of matching non-parametric tokens in the pair of log messages,
computing a similarity score based on the total number of different non-parametric tokens and the total number of pairs of matching non-parametric tokens, and
identifying the pair of log messages as having the same event type and belonging to the same log message group that corresponds to the event type in response to the similarity score being greater than a token matching threshold.

4. The method of claim 2 wherein determining the representative log message for each log message group comprises:
for each log message group of log messages with the same event type,
computing an average similarity score for each log message of a log message group,
identifying the maximum average similarity score of a plurality of average similarity scores computed for log messages in the log message group, and
setting a representative log message equal to the log message with the maximum average similarity score.

5. The method of claim 2 wherein determining the representative log message for each log message group comprises:
for each log message group of log message with the same event type,
determining a count of similarity scores that are greater than a degree threshold for each of the log messages of the log message group,
identifying the maximum count of the counts of similarity scores associated with the log messages, and
setting a representative log message equal to the log message of the log message group with the maximum count.

6. The method of claim 1 wherein compressing the representative log messages into codewords to obtain the lossy compressed set of log messages comprises:
computing a probability distribution of event types of the log messages in the original set of log messages;
ordering the probabilities of the probability distribution from largest to smallest to obtain an ordered probability distribution;
constructing a source coding tree with leaves that correspond to the representative log messages and edges that correspond to binary digits based on the ordered probability distribution;
traversing paths of the source coding tree to create codewords for each of the representative log messages; and
overwriting the representative log messages with corresponding codewords to obtain the lossy compressed set of log messages.

7. The method of claim 1 wherein replacing the original set in the log message database with the lossy compressed set comprises deleting the original set.

8. A computer system for compressing log messages stored in a log message database, the computer system comprising:
one or more processors;
one or more data-storage devices; and
machine-readable instructions stored in the one or more data-storage devices that when executed using the one or more processors controls the system to performance operations comprising:
retrieving an original set of log messages from the log message database;
overwriting the log messages of the original set with representative log messages of the log messages;
compressing the representative log messages into codewords to obtain a lossy compressed set of log messages; and
replacing the original set in the log message database with the lossy compressed set.

9. The computer system of claim 8 wherein overwriting the log messages of the original set with representative log messages comprises:
forming the log messages into log message groups based on event types of the log messages;
determining a representative log message for each log message group, each representative log message corresponding to an event type of the log messages; and
overwriting the log messages of the original set with representative log messages that correspond to the event types of the log messages.

10. The computer system of claim 9 wherein forming the log messages into log messages groups comprises:
extracting non-parametric tokens from the log messages using regular expressions or Grok expressions;
for each pair of log messages,
counting the total number of different non-parametric tokens in the pair of log messages,
counting the total number of pairs of matching non-parametric tokens in the pair of log messages,
computing a similarity score based on the total number of different non-parametric tokens and the total number of pairs of matching non-parametric tokens, and
identifying the pair of log messages as having the same event type and belonging to the same log message group that corresponds to the event type in response to the similarity score being greater than a token matching threshold.

11. The computer system of claim 9 wherein determining the representative log message for each log message group comprises:
for each log message group of log messages with the same event type,
computing an average similarity score for each log message of a log message group,
identifying the maximum average similarity score of a plurality of average similarity scores computed for log messages in the log message group, and
setting a representative log message equal to the log message with the maximum average similarity score.

12. The computer system of claim 9 wherein determining the representative log message for each log message group comprises:
for each log message group of log message with the same event type,
determining a count of similarity scores that are greater than a degree threshold for each of the log messages of the log message group,
identifying the maximum count of the counts of similarity scores associated with the log messages, and
setting a representative log message equal to the log message of the log message group with the maximum count.

13. The computer system of claim 8 wherein compressing the representative log messages into codewords to obtain the lossy compressed set of log messages comprises:
computing a probability distribution of event types of the log messages in the original set of log messages;
ordering the probabilities of the probability distribution from largest to smallest to obtain an ordered probability distribution;
constructing a source coding tree with leaves that correspond to the representative log messages and edges that correspond to binary digits based on the ordered probability distribution;
traversing paths of the source coding tree to create codewords for each of the representative log messages; and
overwriting the representative log messages with corresponding codewords to obtain the lossy compressed set of log messages.

14. The computer system of claim 8 wherein replacing the original set in the log message database with the lossy compressed set comprises deleting the original set.

15. A non-transitory computer-readable medium having instructions encoded thereon for enabling one or more processors of a computer system to perform operations comprising:
overwriting log messages of an original set of log messages stored in a log file of a log message database with representative log messages of the log messages;
compressing the representative log messages into codewords to obtain a lossy compressed set of log messages; and
replacing the original set in the log message database with the lossy compressed set.

16. The medium of claim 15 wherein overwriting the log messages of the original set with representative log messages comprises:
forming the log messages into log message groups based on event types of the log messages;
determining a representative log message for each log message group, each representative log message corresponding to an event type of the log messages; and
overwriting the log messages of the original set with representative log messages that correspond to the event types of the log messages.

17. The medium of claim 16 wherein forming the log messages into log messages groups comprises:
extracting non-parametric tokens from the log messages using regular expressions or Grok expressions:
for each pair of log messages,
counting the total number of different non-parametric tokens in the pair of log messages,
counting the total number of pairs of matching non-parametric tokens in the pair of log messages,
computing a similarity score based on the total number of different non-parametric tokens and the total number of pairs of matching non-parametric tokens, and
identifying the pair of log messages as having the same event type and belonging to the same log message group that corresponds to the event type in response to the similarity score being greater than a token matching threshold.

18. The medium of claim 16 wherein determining the representative log message for each log message group comprises:
for each log message group of log messages with the same event type,
computing an average similarity score for each log message of a log message group,
identifying the maximum average similarity score of a plurality of average similarity scores computed for log messages in the log message group, and
setting a representative log message equal to the log message with the maximum average similarity score.

19. The medium of claim 16 wherein determining the representative log message for each log message group comprises:
for each log message group of log message with the same event type,
determining a count of similarity scores that are greater than a degree threshold for each of the log messages of the log message group,
identifying the maximum count of the counts of similarity scores associated with the log messages, and
setting a representative log message equal to the log message of the log message group with the maximum count.

20. The medium of claim 15 wherein compressing the representative log messages into codewords to obtain the lossy compressed set of log messages comprises:
computing a probability distribution of event types of the log messages in the original set of log messages;
ordering the probabilities of the probability distribution from largest to smallest to obtain an ordered probability distribution;
constructing a source coding tree with leaves that correspond to the representative log messages and edges that correspond to binary digits based on the ordered probability distribution;
traversing paths of the source coding tree to create codewords for each of the representative log messages; and
overwriting the representative log messages with corresponding codewords to obtain the lossy compressed set of log messages.

21. The medium of claim 15 wherein replacing the original set in the log message database with the lossy compressed set comprises deleting the original set.
